(19) United States
(12) Patent Application Publication
(10) Pub. No.: US 2011/0167357 A1
(43) Pub. Date: Jul. 7, 2011

(54) Scenario-Based Content Organization and Retrieval

(76) Inventors: Todd Benjamin, Saratoga, CA (US); Brett Bilbrey, Sunnyvale, CA (US)

(21) Appl. No.: 12/652,686

(22) Filed: Jan. 5, 2010

(51) Int. Cl. G06F 3/01; G06F 3/033

(52) U.S. Cl. 715/753; 715/863

(57) ABSTRACT

Methods, systems, and computer-readable media for scenario-based content categorization, retrieval, and presentation are disclosed. At a first moment in time, a first event scenario is detected by a mobile device, where the first event scenario is defined by one or more participants and one or more contextual cues concurrently monitored by the mobile device and observable to a human user of the mobile device. An information bundle is created in real-time for the first event scenario, where the information bundle includes one or more documents accessed during the first event scenario and is retrievable according to the one or more contextual cues. Access to the one or more documents is automatically provided on the mobile device during a second event scenario that is related to the first event scenario by one or more common contextual cues. Other scenario-based content retrieval and presentation methods are also disclosed.

### TECHNICAL FIELD

This subject matter is generally related to organization and retrieval of relevant information on a mobile device.

### BACKGROUND

Modern mobile devices such as “smart” phones have become an integral part of people's daily lives. Many of these mobile devices can support a variety of applications. These applications can relate to communications such as telephony, email and text messaging, or organizational management, such as address books and calendars. Some mobile devices can even support business and personal applications such as creating presentations or spreadsheets, word processing and providing access to websites and social networks. All of these functions applications can produce large volumes of information that needs to be organized and managed for subsequent retrieval. Although modern mobile devices can provide storage and access of information, it is often the user's responsibility to manually organize and manage the information. Conventional methods for organizing and managing information include allowing the user to store information or content into directories and folders of a file system and use descriptive metadata, keywords or filenames to name the directories and folders. This manual process can be laborious and time-consuming.

### SUMMARY

Methods, systems, and computer-readable media for scenario-based content categorization, retrieval, and presentation are disclosed. At a first moment in time, a first event scenario is detected by a mobile device, the first event scenario is defined by one or more participants and one or more contextual cues concurrently monitored by the mobile device and observable to a human user of the mobile device. An information bundle is created in real-time for the first event scenario, where the information bundle includes one or more documents accessed during the first event scenario and is retrieval according to the one or more contextual cues. Access to the one or more documents is automatically provided on the mobile device during a second event scenario that is related to the first event scenario by one or more common contextual cues. Other scenario-based content categorization, retrieval, and presentation methods are also disclosed.

In various implementations, the methods and systems disclosed in this specification may offer one or more of the following advantages.

Metadata used for categorizing documents can be automatically generated in real-time without user intervention. The automatic generation of metadata can be triggered by an occurrence of an event scenario (e.g., a meeting or an appointment) which can be defined by a group of participants, subject matter, and/or one or more contextual cues that can be detected by the mobile device. Documents (including e.g., files, information, or content) that are accessed during the event scenario, or are otherwise relevant to the event scenario, can be associated with the metadata for the event scenario and categorized in real-time using the metadata. With the disclosed methods and systems the manual post-processing of information by the user becomes unnecessary and backlogs of organization tasks and information can be significantly reduced.

The automatically generated metadata are not only descriptive of the content and the relevance of the documents, but also the event scenario associated with the documents. The event scenario can be described by various sensory and functional characterizations (e.g., contextual cues) that are directly perceivable and/or experienced by the user of the mobile device during the event scenario. When documents are associated with an event scenario, they can be retrieved as a group or individually based on the metadata describing the documents or on the metadata that describe the event scenario, such as sensory/descriptive and functional characterizations of people participating in the event scenario, the time and place of the event scenario, or the tasks that were presented or carried out during the event scenario.

In one example, documents associated with a past event scenario can be automatically retrieved and presented to the user during an occurrence of a related event scenario (e.g., a follow-up meeting of the previous meeting). In such cases, the user does not have to manually search and locate the documents relevant to the related event scenario, since relevant information can be automatically available or presented to the user for direct and easy access during the related event scenario (e.g., presented on a desktop or display of the mobile device). Detection of related event scenarios can be based on information derived from the user's electronic calendars, emails, manual associations, and/or common contextual cues that are both currently and previously present and any other desired trigger events for detecting related event scenarios.

In addition, the scenario-based content categorization and retrieval methods described herein are compatible with conventional file systems. For example, a single document stored in a directory or folder hierarchy can be associated with multiple event scenarios regardless of the actual storage location in the file system. New documents can be created and manually added to an existing information bundle associated with a previously recorded event scenario. A search for documents associated with an event scenario can be performed using content keywords, filenames, and sensory/descriptive and functional characterizations of the event scenarios. Because the sensory/descriptive and functional characterizations associated with an event scenario can reflect the actual experience and perception of the user during the event scenario, the characterizations can serve as additional memory cues for retrieving and filtering event scenario documents even if the user does not accurately remember the content of the documents.

Information bundles created for multiple event scenarios for a user over time can be processed further to build a personal profile for the user. Personal routines can be derived from the information bundles, and the personal profile categorizes information and/or content based on the derived routines (e.g., meals, shopping, childcare, entertainment, banking, etc.) performed by the user at specific times and/or places. The information and/or content relevant to a particular routine can be automatically provided or presented to the user at the specific time and/or place where that particular routine is usually performed by the user. This saves the user from having to manually locate the necessary information and/or content each time the user performs a routine task.

Moreover, even when the user is traveling outside of the user's geographic area, alternative places, times, and/or relevant information can be suggested for a routine based on the information stored in the personal profile to enable the user to carry out routines in the new geographic area.

The details of one or more embodiments of the subject matter described in the specification are set forth in the accompanying drawings and the description below. Other features, aspects, and advantages of the subject matter will become apparent from the description, the drawings, and the claims.

### DESCRIPTION OF DRAWINGS

FIG. 1 illustrates the detection and monitoring of an example event scenario.

FIG. 2 illustrates creation of an example information bundle for the event scenario.

FIG. 3 illustrates the presentation of content associated with the event scenario during a subsequent, related event scenario.

FIG. 4 illustrates a personal profile built according to the recorded event scenarios of a user.

FIG. 5 is a flow diagram of an example process for scenario-based content categorization.

FIG. 6 is a flow diagram of an example process for creating an information bundle for an event scenario.

FIG. 7 is a flow diagram of an example process for presenting content during a subsequent, related event scenario.

FIG. 8 is a flow diagram of an example process for presenting content in response to a query using contextual cues present in an event scenario.

FIG. 9 is a flow diagram of an example process for building a personal profile and presenting content based on the personal profile.

FIG. 10 is a block diagram of an example mobile device for performing scenario-based content categorization and retrieval.

FIG. 11 is a block diagram of an example mobile device operating environment for scenario-based content organization and retrieval.

FIG. 12 is a block diagram of an example implementation of the mobile device for performing scenario-based content organization and retrieval.

### DETAILED DESCRIPTION

### Perception Capabilities of a Mobile Device

Typically, a multifunction mobile device can detect events and changes occurring within the software environment of the mobile device through various state monitoring instructions. For example, a calendar application can check the internal clock of the mobile device to determine whether the scheduled start time of a particular calendar event is about to be reached. The calendar application can generate and present a notification for the imminent start of the scheduled event at a predetermined interval before the scheduled start time to remind the user of the event. For another example, when a user accesses a document on the device directly or through a software application, such as opening, downloading, moving, copying, editing, creating, sharing, sending, annotating, or deleting the document, the mobile device can detect and keep records of these accesses.

In addition to the changes occurring in the software environment, many multi-functional mobile devices also have various built-in sensory capabilities for detecting the current status or changes occurring to the mobile device's own physical state and/or to the physical environment immediately surrounding the mobile device. These sensory capabilities make it possible for a mobile device to detect and record an event scenario in a way that mimics how a human user of the mobile device would perceive, interpret, and remember the event scenario.

Because each aspect of an event scenario experienced by the human user can potentially be used by the brain as a memory cue to later retrieve other pieces of information conveyed to the user during the event scenario, by recognizing and recording these event scenarios on the mobile device, the mobile device can facilitate the organization and retrieval of relevant and useful information for the user.

In some implementations, information that characterizes an event scenario includes statuses and changes that can be directly detected by the built-in sensors of the mobile device. For example, a GPS system on the mobile device can enable the mobile device to register status of and changes to its own physical location; a proximity sensor on the mobile device can enable the mobile device to register whether a user is physically close in proximity to the device or has just moved away; an accelerometer on the mobile device can enable the mobile device to register its own physical movement patterns; a magnetic compass on the mobile device can enable the device to register its own physical orientation relative to a geographical direction; an ambient light sensor on the mobile device can enable the mobile device to detect status of and changes to the lighting conditions around the mobile device. Other sensors can be included in the mobile device to detect other statuses of and changes to the physical environment immediately surrounding the mobile device. These detected statuses and/or their changes can be directly perceived by or conveyed to the user present in proximity to the device.

In some implementations, in addition to the built-in sensors, the mobile device can also include software instructions to obtain and process additional information from external sources to enrich the information that the mobile device has obtained using its built-in sensors, and use the additional information to characterize the event scenario. For example, in addition to a GPS location (e.g., a street address or a set of geographic coordinates) obtained using the built-in GPS system, the mobile device can query a map service or other data sources to determine other names, identifiers, functional labels and/or descriptions for the GPS location (e.g., “Nan's Deli,” “http://www.nansdeli.com,” “a small grocery store and deli,” “specialty in gourmet cheeses,” “a five star customer rating on CityEats,” “a sister store in downtown,” “old-world charm,” etc.). These other names, identifiers, functional labels, and/or descriptions are information that a person visiting the place can quickly obtain and intuitively associate with the place, and can serve as memory cues for the person to recall the place.

In some implementations, even if the mobile device does not include a built-in sensor for a particular perceivable status of its surrounding environment (e.g., temperature, air quality, weather, traffic condition, etc.), this information can be obtained from other specialized sources based on the particular location in which the mobile device is currently located, and used to describe an event scenario occurring at the location. For example, statuses or properties such as temperature, air quality, weather, lighting, and traffic condition, and/or atmosphere around a mobile device can be directly experienced by a human user present in the physical environment immediately surrounding the mobile device; therefore, such status information can also serve as memory cues for recalling the particular event scenario that occurred in this environment.

In some implementations, the mobile device can include image, audio, and video capturing capabilities. Images, audios, and video segments of the surrounding environment can be captured in real-time as an event scenario occurs. These images, audios, and videos can then be processed by various techniques to derive names, locations, identifiers, functional labels, and descriptions of the scenario occurring immediately surrounding the mobile device. For example, facial recognition and voice recognition techniques can be used to identify people present in the event scenario. Image processing techniques can be used to derive objects, visual landmarks, signs, and other features of the environment. In addition, text transcripts can be produced from the recordings of the conversations that occurred in the event scenario, and information such as names of people, subject matter of discussion, current location, time, weather, mood, and other keywords that appeared in the conversations can be extracted from the transcripts. The derived information from the recordings can also serve as memory cues for later retrieving the memory of this event scenario, and used to describe or characterize this event scenario.

### Detection of an Event Scenario

The monitoring of the software environment and physical status of the mobile device, and the physical environment immediate around the mobile device can be ongoing, provided that enough computing resources are available to the mobile device. Alternatively, some of the monitoring can start only after a record-worthy event scenario has been detected.

The detection of a meaningful event scenario that warrants further processing and/or a permanent record can be based on a number of indicators. For example, a notification of the imminent start of a scheduled calendar event can be an indicator that a record-worthy event scenario is about to occur. For another example, presence of one or more of specially-designated people (e.g., best friends, supervisors, doctor, accountant, lawyer, etc.) can be used as an indicator for a record-worthy event scenario. For yet another example, detected presence of the mobile device in a specially-designated location (e.g., doctor's office, the bank, Omni Parker House, conference room A, etc.) can also be used as an indicator for a record-worthy event scenario. In some implementations, the end of an event scenario can be detected according to the absence or expiration of all or some of the indicator(s) that marked the start of the event scenario.

In addition to automatically triggered indicators (such as those shown in the above examples), manual triggers can also be used to mark the start of an event scenario. For example, a software or hardware user interface element can be provided to receive user input indicating the start of an event scenario. In some implementations, the same user interface element can be a toggle button that is used to receive user input indicating the end of the event scenario as well. In some implementations, different user interface elements (e.g., virtual buttons) can be used to mark the start and the end of the event scenario. In some implementations, automatic triggers and manual triggers can be used in combination. For example, an automatic trigger can be used to mark the start of an event scenario, and a manual trigger is used for the end, and vice versa. In some implementations, a motion gesture can be made with the device and used to trigger a start of an event scenario.

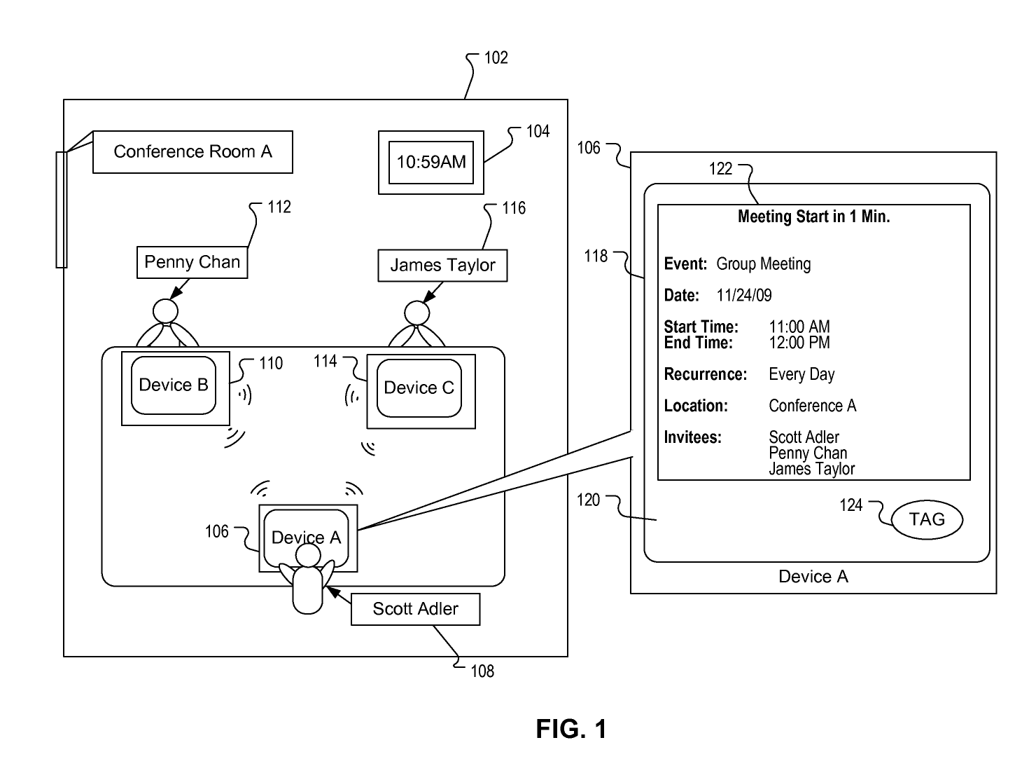

FIG. 1 illustrates an example process for recognizing/detecting an event scenario occurring in proximity to a mobile device, and recording information about various aspects of the event scenario.

An event scenario can include a number of elements, such as the people participating in the event scenario (i.e., the participants), the location at which the participants are gathered, the start and end times of the event scenario, the purpose or subject matter of the gathering, the virtual and/or physical incidents that ensued during the event scenario, the information and documents accessed during the event scenario, various characteristics of the environment or setting of the event scenario, and so on.

In the example scenario shown in FIG. 1, three people (e.g., Scott Adler 108, Penny Chan 112, and James Taylor 116) have gathered in a conference room (e.g., conference room A 102) for a scheduled group meeting. This is meeting is one of a series of routine meetings. The scheduled time for the group meeting is 11:00 am every day, and the meeting is scheduled to last an hour. An electronic meeting invitation had previously been sent to and accepted by each group member. The team leader (e.g., Scott Adler 108) has sent an email to each team member stating the agenda for this meeting is to discuss product quality issues. During this meeting, one or more persons will generate some notes, share some sales data and other product issue related information, and have a discussion about the particular product quality issues raised by the participants. A proposed solution to collaborate with a quality assurance partner will be proposed and his contact information is provided to the other team members.

In this example, each user present at the meeting can carry a respective mobile device (e.g., devices 106, 110, and 114) that implements the scenario-based content categorization and retrieval method described herein. The mobile device (e.g., device 106) can be a tablet device that includes touch-sensitive display 118 and a variety of sensors and processing capabilities for gathering information about the physical environment surrounding the mobile device. The mobile device can also be, for example, a handheld computer, a personal digital assistant (PDA), a cellular telephone, a network appliance, a digital camera, a smart phone, an enhanced general packet radio service (EGPRS) mobile phone, a network base station, a media player, a navigation device, an email device, a game console, or a combination of any two or more of these data processing devices or other data processing devices.

In this example, as the scheduled meeting time approaches, notification window 122 is generated and presented on graphical user interface 120 of the mobile device 106 of one of the meeting participants (e.g., Scott Adler 108). The notification window 122 indicates that a meeting is about to start (e.g., in 1 minute). Other information such as the subject, the date, the start and end times, the recurrence frequency, the location, and the invitees, and so on, can also be included in the notification window 122. This event notification generated by the user's electronic calendar can be used as an indicator that a record-worthy event scenario is about to occur. When the mobile device detects such an indicator, it can register the start of the event scenario.

Alternatively, the user of the mobile device 106 (e.g., Scott Adler 108) can set up an automatic trigger that detects the simultaneous presence of all group members (e.g., Scott Adler 108, Penny Chan 112, and James Taylor 116), and use that as an indicator for the start of the event scenario. For example, when the device 106 senses the presence of the devices associated the other two meeting participants (e.g., devices 110 and 114) through some wireless communications, device 106 can register the start of the event scenario. In some implementations, the presence of devices can be sensed using Bluetooth technology or Radio Frequency Identification (RFID) technology.

Alternatively, the user of the mobile device 106 can set up an automatic trigger that detects the presence of the mobile device 106 in conference room A, and use that as an indicator for the start of the event scenario. For example, when the positioning system on the mobile device 106 determines that its current location is in conference room A, the mobile device 106 can register the start of the event scenario.

Alternatively, the user of the mobile device 106 can set up an automatic trigger that detects no only the simultaneous presence of all group members but also the time (e.g., 11:00 am), and location (e.g., Conference Room A), and use that combination of facts as an indicator for the start of the event scenario.

Alternatively, a user interface element 124 (e.g., a “TAG” button) can be displayed on the graphical user interface 120 of the mobile device 106. When the user (e.g., Scott Adler 124) touches the user interface element 124 on the touch-sensitive display 118 (or use other interactive methods, such as using a pointing device, to invoke the user interface element 124), the mobile device can register this user input as an indicator for the start of the event scenario.

Other methods of detecting or recognizing indicators of recordable event scenarios are possible. For example, in addition to having users specify the indicators, the mobile device 106 can process the previously entered indicators and/or recorded scenarios to derive new indicators for event scenarios that may be of interest to the user.

### Recording the Event Scenario

After the mobile device detects the start of an event scenario, the mobile device can employ its various perception capabilities to monitor and records its own virtual and physical statuses as well as the statuses of its surrounding physical environment during the event scenario until an end of the event scenario is detected.

For example, the mobile device 106 can start an audio recording and/or video recording of the meeting as the meeting progresses. The mobile device 106 can also capture still images of the objects and the environment around the mobile device. These images, audio and video recordings can be streamed in real time to a remote server for storage and processing, or stored locally on the mobile device for subsequent processing.

In addition, the mobile device 106 can perform a self-locate function to determine its own position using a positioning system built-in or coupled to the mobile device 106 (e.g., GPS, WiFi, cell ID). The precision of positioning system can be varied depending on its location. For example, if the mobile device were placed in the wilderness, the positioning system may simply report a set of geographical coordinates. If the mobile device is outdoors in the city street, it may report a street address. If the mobile device is indoors, the positioning system may report a particular floor or room number inside a building. In this example, the positioning system on the mobile device may determine its location to be a particular street address and maybe also a room number (e.g., conference room A).

In addition, the mobile device 106 can communicate with other devices present in the conference room to determine what other people are present in this location. For example, each of the mobile devices 106, 110, and 114 can broadcast its presence and receive the broadcast of other mobile devices within a certain distance. Each mobile device can attach a unique device or user identifier in its broadcast, so that other devices can determine whose device are present nearby. In some implementations, each mobile device can set up different trust levels or encrypt its broadcast, so that only authorized devices can detect and recognize its presence.

The mobile device 106 can also include other sensors, such as an ambient light sensor to determine the lighting condition. Lighting condition can potentially be used to determine the mood or ambience in the room. In a conference room setting, the lighting is likely to be normal. However, if a presentation is shown, the lighting might change to dark. Some included sensors may detect characteristics of the surrounding environment such as the ambient temperature, air quality, humidity, wind flow, etc. Other sensors may detect the physical state of the mobile device, such as the orientation, speed, movement pattern, and so on.

In addition to the real-time data recordings mentioned above, the mobile device 106 can also process these data recordings to derive additional information. For example, the voice recordings can be turned into transcripts and keywords can be extracted from the transcript. These keywords may provide information such as the weather, people's names, locations, time, date, subject matter of discussions, and so on. In some implementations, the audio recordings can be processed by known voice recognition techniques to identify participants of the event scenario.

In some implementations, the audio recordings can also be processed to derive audio landmarks for the event scenario. For example, if there was a fire drill during the meeting, the fire alarm would be an audio landmark that is particular about this event scenario. For another example, if there was a heated argument during the meeting, the loud voices can also be an audio landmark that is particular about this event scenario.

In some implementations, the video recording can also be processed to derive additional information about the meeting. For example, facial recognition techniques can be used to determine the people present at the meeting. Image processing techniques can be used to determine objects present in the environment around the mobile device 106. In this example, the video might shown the wall clock 204 in the conference room, and image processing may derive the current time from the images of the wall clock 204. If the wall clock is an impressive and unique looking object, the mobile device may recognize it as a visual landmark that is particular to this event scenario. Other visual landmarks may include, for example, a particular color scheme in the room, a unique sculpture, and so on.

Sometimes, if the positioning system is not capable of producing a high precision location determination, information derived from the data recordings can be used to improve the precision. For example, signage captured in still images or videos may be extracted and used to help determining the address or room number, etc. Locations may be mentioned in conversations, and extracted from the audio recordings. Locations can have bar code labels which can be scanned to obtain geographic coordinates or other information related to the location. Locations can have radio frequency or infrared beacons which can provide geographic coordinates or other information related to the location.

In addition to processing the data recordings to derive information about the event scenario, the mobile device 106 can also extract information from locally stored documents or query remote servers. For example, the mobile device 106 can gather and process email messages and/or calendar event entries related to the gathering to determine the participants, the location, the time, and the subject matter of the meeting. In addition, the mobile device 106 can query other mobile devices located nearby for additional information if the other mobile devices are at better vantage points for determining such information. In some implementations, the mobile device 106 can query remote data services for additional information such as local weather, traffic report, air quality report, other names of the location, identities of the participants, and so on by providing locally obtained information such as the device's location, nearby devices' identifiers, and so on.

In addition to collecting information about the physical state of the mobile device and the surrounding environment, the device's location, the current time, and the people present nearby, the mobile device also detects access to any documents on the mobile device 106 during the event scenario. A document can be an individual file (e.g., a text or an audio file), a collection of linked files (e.g., a webpage), an excerpt of a file or another document (e.g., a preview of a text file, a thumbnail preview of an image, etc.), a summary of a file or another document (e.g., summary of a webpage embedded in its source code), a file folder, and/or an data record of a software application (e.g., an email, an address book entry, a calendar entry, etc.). A user of the mobile device can access a document in a variety of manners, such as by opening, creating, downloading, sharing, uploading, previewing, editing, moving, annotating, executing, or searching the document.

In the example shown in FIG. 1, if the user of mobile device 106 opened a file stored locally, viewed a webpage online, shared a picture with the other participants, sent an email, made a call from the mobile device, looked up a contact, created some notes, created a file folder for the notes, changed the filename of an existing file, and ran a demo program, the file, the webpage, the picture, the email, the call log and phone number, the address book entry for the contact, the file folder, the file with its new name, and the demo program can all be recorded as document accessed during the event scenario. In some implementations, the particular mode of access is also recorded by the mobile device. For example, the MAC address of a particular access point for WiFi access could be recorded.

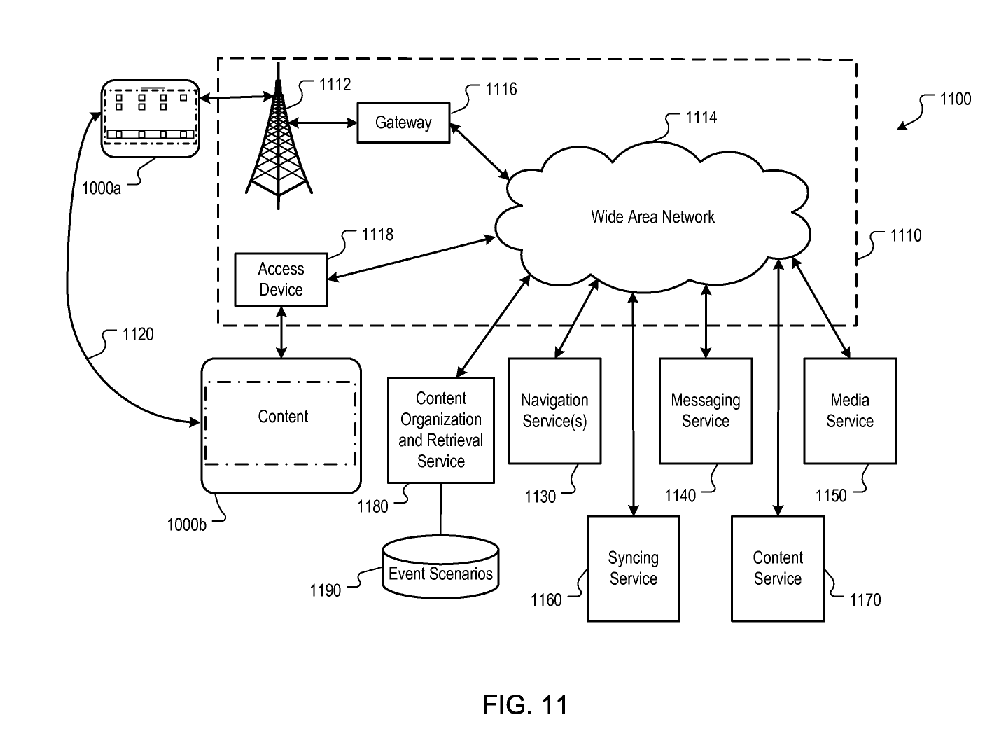

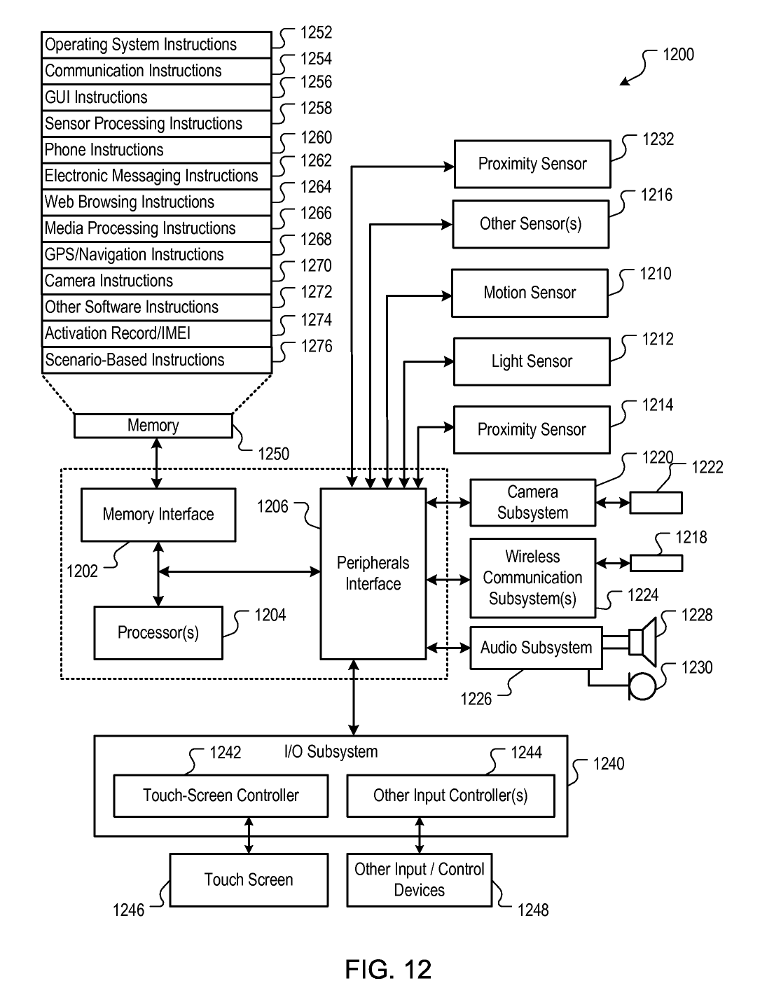

The information about the physical state of the mobile device and the surrounding environment, the device's location, the current time, the people present nearby, and the access to documents on the mobile device 106 during the event scenario can be collected and processed in real-time during the event scenario. Alternatively, information recording can be in real-time during the event scenario, while the processing of recorded raw data to derive additional information can be performed after the end of the event scenario is detected. The processing of raw data can be carried out locally on the mobile device 106 (e.g., according to scenario-based instructions 1276 shown in FIG. 12) or remotely at a server device (e.g., content organization and retrieval service 1180 shown in FIG. 11).

In some implementations, information collected by the mobile device can be uploaded to a server (e.g., a server for the content organization and retrieval service 1180 shown in FIG. 11) or shared with other mobile devices present in the event scenario. In some implementations, the server can receive data from multiple devices present in the event scenario, and synthesize the data to create a unified data collection for the event scenario. The server can then provide access to the unified data collection to each of the mobile devices present in the event scenario.

In some implementations, a participant can become part of the event scenario through a network connection. For example, the participant can join the meeting through teleconferencing. His presence can be detected and recorded in the audio recording of the event scenario. For another example, the participant can join the meeting through video conferencing or an internet chat room. The presence of the remote participants can be detected and recorded in the audio/video recording or the text transcript of the chats. The remote participants can also share data about the event scenario with other mobile devices present at the local site, either directly or through a central server (e.g., a server for the content organization and retrieval service 1180 shown in FIG. 11).

### Creating an Information Bundle for the Event Scenario

As described above, the mobile device can obtain much information about an event scenario, either directly through built-in sensors, by processing recorded data, querying other data sources, or by sharing information with other devices. The different pieces of information can be associated with one another to form an information unit or information bundle for the event scenario. The information bundle includes not only a simple aggregation of data items associated with the event scenario, but also metadata that describe each aspect of the event scenario, where the metadata can be derived from the data items as a whole.

The creation of the information bundle can be carried out locally on the mobile device, remotely on a server, or partly on the mobile device and partly on the remote server (e.g., a server for the content organization and retrieval service 1180 shown in FIG. 11). In some implementations, the processes for recording the event scenario and creating an information bundle are integrated into a single process.

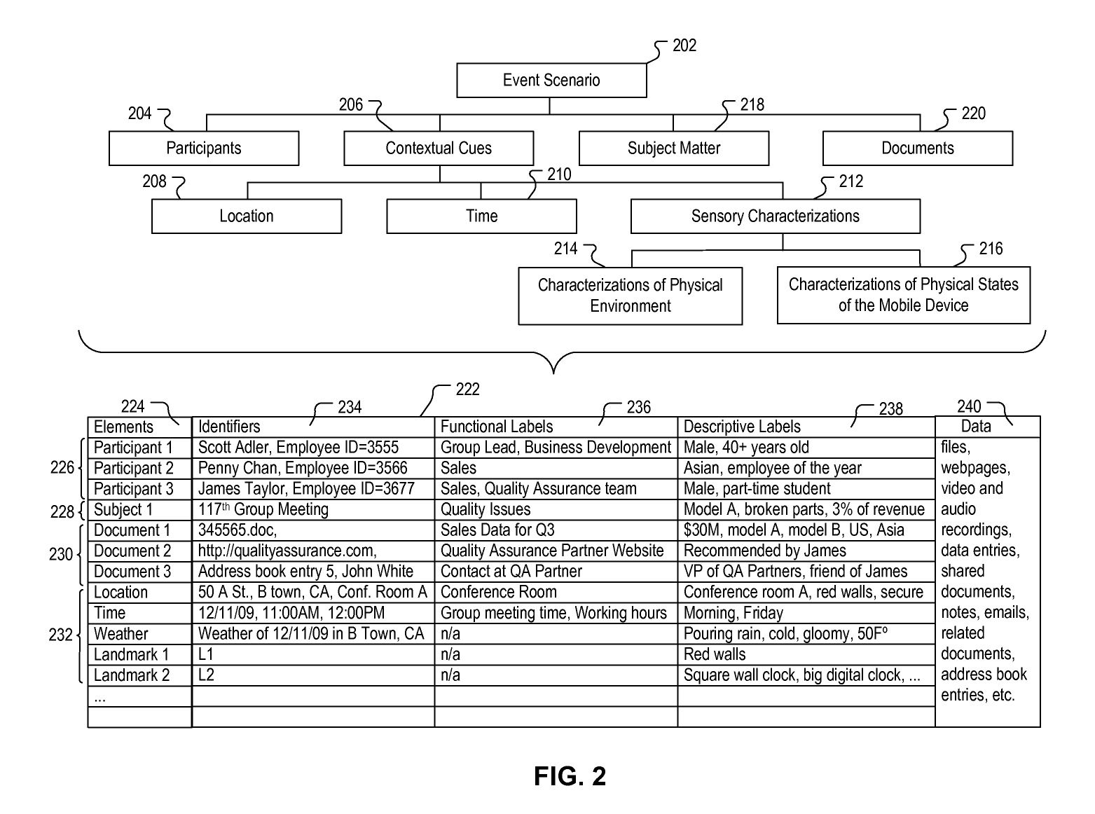

FIG. 2 illustrates an example information bundle created for the event scenario shown in FIG. 1. Based on the recorded/collected information about the event scenario, metadata describing the event scenario can be generated. These metadata include, for example, respective identifiers, functional labels and descriptive labels for each aspect and sub-aspect of the event scenario, including the location, the time, the participants, the subject matter, and the documents associated with the event scenario. The recorded raw data, the processed data, the derived data, and the shared data about the event scenario (or collectively, “data items”) can also be included in the information bundle for the event scenario.

As shown in FIG. 2, the example event scenario 202 is defined by one or more participants 204 present in the example event scenario 202 (locally and/or remotely). The example event scenario 202 is further defined by a plurality of contextual cues 206 describing the example event scenario 202. The contextual cues 206 include the location 208 and the time 210 for the event scenario 202, and various sensory characterizations 212. The various sensory characterizations 212 include characterizations 214 for the physical environment surrounding the mobile device and characterizations 216 for the physical states of mobile device, for example. Examples of the sensory characterizations 212 include the ambient temperature, the air quality, the visual landmarks, the audio landmarks, and the weather of the surrounding environment, the speed of the mobile device, and other perceivable information about the mobile device and/or its external physical environment.

In addition to the participants 204, the location 208, the time 210, and the various sensory characterizations 212, the event scenario 202 is also defined by one or more subject matter (or purpose) 218 for which the event scenario has occurred or came into being. The subject matter or purpose 218 can be determined through the calendar entry for the event scenario, or emails about the event scenario, keywords extracted from the conversations that occurred during the event scenario, and/or documents accessed during the event scenario. An event scenario may be associated with a single subject matter, multiple related subject matters, or multiple unrelated subject matters.

In addition, the event scenario 202 is associated with a collection of documents 220. The collection of documents associated with the event scenario 202 includes documents that were accessed during the event scenario 202. In some event scenarios, no documents were accessed by the user, however, recordings and new data items about the event scenario are created by the mobile device. These recordings and new data items can optionally be considered documents associated with the event scenario. In some implementations, no documents were accessed, however, the mobile device may determine that certain documents are relevant based on the participants, the subject matter, the recordings and new data items created for the event scenario. These relevant documents can optionally be considered documents associated with the event scenario as well.

In order to create an information bundle (e.g., information bundle 222), metadata is generated automatically by the mobile device or by a remote server that receives the information (e.g., the data items 240) associated with the event scenario 202. The metadata include, for example, names/identifiers, functional and descriptive labels, and/or detailed descriptions of each element of the event scenario 202.

Following the example shown in FIG. 1, the information bundle 222 can be created for the event scenario 202. In some implementations, the information bundle 222 can include data items 240 collected in real-time during the event scenario 202. The data items 204 can include, for example, files, web pages, video and audio recordings, images, data entries in application programs (e.g., email messages, address book entry, phone numbers), notes, shared documents, GPS locations, temperature data, traffic data, weather data, and so on. Each of these data items are standalone data items that can be stored, retrieved, and presented to the user independent of other data items. The data items 240 can include data items that existed before the start of the event scenario 202, created or obtained by the mobile device during the event scenario 202. In some implementations, the data items 202 can also include data items that are generated or obtained immediately after the event scenario 202, such as shared meeting notes, summary of the meeting, transcripts of the recordings, etc.

For each aspect and sub-aspect (e.g., elements 224) of the event scenario 202 depicted in the information bundle 222, such as participants 226, subject matter 228, associated documents 230, and contextual cues 232, one or more identifiers 234 can be derived from the data items 240 or other sources.

For example, there were three participants in the event scenario 202, for each participant, the identifiers can include the name of the participant, an employee ID of the participant, and/or a nick name or alias of the participant, an email address of the participant, etc. These identifiers are used to uniquely identify these participants. These identifiers can be derived from the calendar event notification, the device identifiers of the nearby devices that are detected by the mobile device 106, the conversation recorded during the meeting, etc.

Further, in this example, there was a single subject matter for this event scenario. The subject matter can be derived from the calendar event entry for the event scenario. The identifiers for the subject matter can be the subject line (if unique) of the calendar entry for the meeting or a session number in a series of meetings that had previously occurred. The identifiers for the subject matter are unique keys for identifying the subject matter of the event scenario. In some cases, a unique identifier can be generated and assigned to the subject matter for each of several event scenarios, if the subject matter is common among these several scenarios. For example, an identifier for the subject matter “Group Meeting” can be “117^{th} Group Meeting” among many group meetings that have occurred.

In this example, three documents were accessed during the event scenario 202. Depending on the document type, the identifiers for each of these documents can be a filename, a uniform resource location (URL) of the document (e.g., a webpage), an address book entry identifier, an email message identifier, and so on. The identifiers for a document uniquely identify the document for retrieval. In some implementations, identifiers for a document can be derived from the information recorded or obtained during the event scenario. For example, when typed notes are created during the group meeting by the user of the mobile device 106, the notes can be saved with a name with information extracted from the notification of the calendar event according to a particular format. For example, the particular format can be specified in terms of a number of variables such as “$author_$date_$subject.notes,” and filled in with the information extracted from the event notification as “ScottAdler_{—}12-11-2009_GroupMeeting.notes.”

For a location, the identifier can be a street address, a set of geographical coordinates, a building name, and/or a room number. In some implementations, depending on what the location is, the identifier can be a store name, station name, an airport name, a hospital name, and so on. The identifiers of the location uniquely identify the location at which the event scenario has occurred.

For the time associated with the event scenario 202, the identifier can be a date and a time of day, for example. For other contextual cues, the identifiers can be used to uniquely identify those contextual cues. For example, for the “weather” element of the event scenario, the identifier can be “weather on 12/11/09 in B town,” which uniquely identifies the weather condition for the event scenario. For other contextual cues, such as a visual landmark, the identifier can be automatically generated (e.g., “L1” or “L2”) for uniquely identifying the landmarks in the event scenario 202.

In addition to identifiers 234, each aspect and sub-aspect (e.g., the elements 224) of the event scenario 202 can also be associated with one or more functional labels 236. The functional labels 236 describe one or more functions of the participants, subject matters, documents, location, time, and/or other contextual cues. For example, a functional label of a participant can be a professional title of the participant, the participant's role in the event scenario, and so on. The functional label of a subject matter can be the particular purpose of the event or gathering, an issue to be addressed during the event scenario, and so on. The functional label for a document can be a functional characterization of the content of the document, particularly in the context of the event scenario. For example, a function label for a document can be a sales report, a product brochure, a promotional material, a translation, and so on. In this particular example, one of the documents is a webpage for a business partner and the functional label would describe the webpage as such (e.g., “website of business partner”). In this particular example, another document is the CV card of the contact at the business partner, and the functional label would describe the contact as such (e.g., “contact at business partner”). Each functional label characterizes a function or purpose of an aspect of the event scenario, particularly in the context of the event scenario. A functional label does not have to be uniquely associated with any particular data item or identifier. A search using a functional label may return more than one participant, locations, documents, etc. in the same or different event scenarios.

In addition to identifiers 234 and functional labels 236, a number of descriptive labels 238 can also be associated with each aspect or sub-aspect (the elements 224) of the event scenario 202. For example, each participant can be associated with one or more descriptive labels. These descriptive labels are descriptions that an observer of the event scenario is likely to use to describe the participants, e.g., in physical appearances, reputation, characteristics, and so on. For another example, the descriptive label associated with a subject matter can be the detailed aspects of the subject matter discussed during the meeting. For example, these descriptive labels would be keywords that a participant or observer of the event scenario is likely to use to describe what was discussed during the event scenario. For another example, the descriptive labels associated with a document can include keywords associated with the document, keywords describing a feature of the document (e.g., funny, well-written), and so on. These descriptive labels can be extracted from the transcripts of the conversations that occurred in the event scenario. For example, if a document was opened and shared during the event scenario, one or more key words spoken during the presentation of the shared document can be used as descriptive labels for the document. In addition, descriptive labels of the document can also be extracted from the filename, metadata, and content of the document itself.

In some implementations, descriptive labels can also be associated with other contextual cues. For example, in addition to the functional label of the location for the event scenario, a number of descriptive labels can be associated with the location as well. For example, if the conference room A is also known as the “red room” because it has red walls. Then the keyword “red walls” can be associated with the location as a descriptive label. In addition, if the conference room A is in a secure zone of the office building. The descriptive label “secure” can also be associated with the location. These descriptive labels can be derived from keyword analysis of the audio transcripts, image processing of the video recordings of the event scenario, or other sources.

Other descriptive labels, such as the descriptive labels for the weather or the landmarks, can also be obtained either through the transcripts of the conversations or image analysis of the video recordings. Other source of the information can also be used.

In some implementations, the same element (e.g., the same participant, location, and/or landmarks) may appear in multiple event scenarios, descriptive labels for that element can be shared among the different event scenarios.

In some implementations, identifiers, functional labels, and descriptive labels can be extracted from other data sources based on the data items currently available. In some implementations, frequency of each functional label or descriptive label's occurrences in an event scenario can be determined, and frequently occurring functional labels and descriptive labels can be given a higher status or weight during retrieval of the information bundle for the event scenario based on these frequently occurring labels.

In some implementations, the information bundle 222 can also include copies of the documents or links or references by which the documents can be subsequently retrieved or located. In some implementations, the user can review the information bundle 222 at the end of the event scenario and exclude certain information or documents from the event bundle 222. In some implementations, the user can manually associate certain information and/or documents with the event bundle 222 after the creation of the information bundle 222.

The information bundle 222 can be stored locally at the mobile device or remotely at a central server. Alternatively, the metadata for many event scenarios can be put into an index stored at the mobile device or the remote server, while the data items and/or associated documents are stored at their original locations in the file system (either on the mobile device or the remote server).

### Presenting Content during a Related Event Scenario

After an information bundle has been created for an event scenario, and stored either locally at the mobile device or remotely at a central server, the information bundle, or the documents and data items referenced in the information bundle can be automatically retrieved and presented to the user of the mobile device during a subsequent event scenario that is related to the previous event scenario.

The relatedness of two event scenarios can be determined by the mobile device based on a number of indicators. Each of the indicators for detecting an event scenario described above can also be used to detect the start of the subsequent, related event scenario as well.

For example, when an event notification is generated and presented on a mobile device indicating the imminent start of a scheduled calendar event, the mobile device can determine whether the scheduled event relates to any previously recorded events. If the event notification refers to a previous scheduled event, then the previous and the current events can be considered related events, and the two event scenarios can be considered related event scenarios. Therefore, at the start of the current event scenario, the mobile device can automatically retrieve the information bundle associated with the previous event scenario, and present information and content (e.g., documents) associated with the previous event scenario on the mobile device (e.g., in a folder on the home screen of the mobile device).

In some implementations, a related event scenario can be detected based on one or more common elements appearing in the current and previously recorded event scenarios. The criteria for recognizing a related event scenario based on common elements can be specified by the user of the mobile device. For example, the user can specify that two event scenarios are considered related if they share the same group of participants. For another example, two event scenarios can be considered related if they have the same subject matter (e.g., as determined from the calendar notifications). For yet another example, two event scenarios can be considered related if they have the same location (e.g., two visits to the doctor's office). Other automatically detectable indicators can be specified to relate two event scenarios. In some implementations, a user can also manually associate two event scenarios, for example, by indicating in a calendar entry a link to a previously recorded event scenario.

In some implementations, when the mobile device determines that a current event scenario is related to a previously recorded event scenario, the mobile device automatically retrieves the information bundle associated with the previously recorded event scenario, and presents all content and information available in the information bundle. In some implementations, the mobile device only retrieves and/or presents the documents or data items in the information bundle associated with the previously recorded event scenario. In some implementations, only a subset of documents or data items (e.g., the documents previously accessed or the documents previously created) are retrieved and/or presented on the mobile device. In some implementations, only references or links to information content are presented on the mobile device, and the information and content are retrieved only if the user selects the respective references and links. In some implementations, the information and content from the information bundle are copied and the copies are presented on the mobile device.

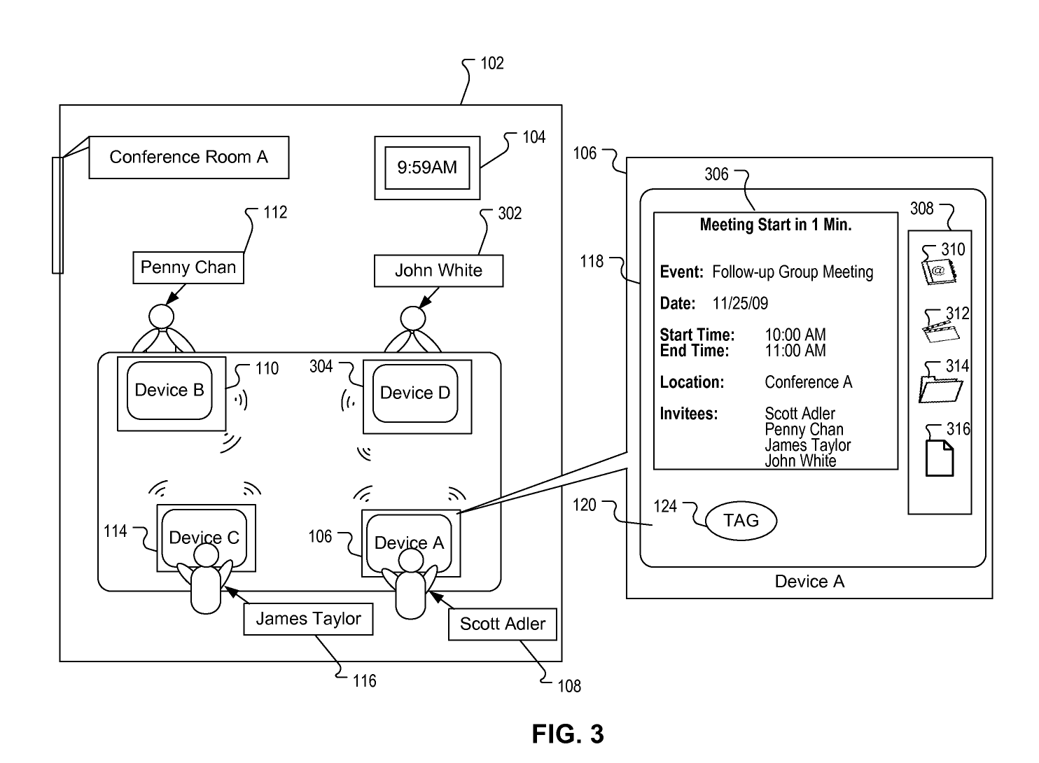

FIG. 3 illustrates the retrieval and presentation of content from the information bundle of a previously recorded event scenario upon the detection of a subsequent, related event scenario.

Following the event scenario (e.g., the group meeting) shown in FIG. 1 and the creation of the information bundle 222 shown in FIG. 2, a follow-up meeting was scheduled and is about to occur in the same conference room A. In this scenario, a business contact (e.g., John White 302) that was mentioned in the previous meeting was invited to join this follow-up meeting. Close to the scheduled start of the follow-up meeting, an event notification 306 is generated and presented on the mobile device 106 of the meeting organizer (e.g., Scott Adler 108).

In this event scenario, the new participant John White 302 also has a mobile device (e.g., device 304). In some implementations, depending on the security settings of the information bundle, the device 304 of the new participant “John White 302” may be given permission to access the information bundle 222 created for the previous group meeting. In some implementations, the permission to access may be provided in a calendar invitation sent from the meeting organizer (e.g., Scott Adler 108) to the new meeting participant (e.g., John White 302). When a notification for the current meeting is generated on the device 304 of the new participant, the information bundle may be retrieved from one of the other devices currently present (e.g., any of the devices 106, 110, and 114) or from a central server storing the information bundle. The content from the retrieved information bundle for the previous meeting can be presented on the display of the mobile device 304 of the new participant. In some implementations, the retrieval and presentation of the information may be subject to one or more security filters, such that only a subset of content from the information bundle is retrieved and presented on the mobile device 304 of the new participant.

In this example, a notification 306 for the follow-up meeting has been generated and presented on the mobile device 106 of the original meeting participant (e.g., Scott Adler 108). The notification 306 shows the subject, the date, the start and end times, the location, and the invitees of the follow-up meeting. A corresponding event scenario for the follow-up meeting can be detected based on the methods similar to that described with respect to the detection of the event scenario associated with the first group meeting.

In this example, a user interface element 308 can be presented on the home screen of the mobile device 106, where the user interface element 308 includes other user interface elements (e.g., user interface elements 310, 312, 314, and 316) for content and information associated with the event scenario of the previous group meeting. In some implementations, the user interface element 308 can be a representation of a folder for the content associated with the previously recorded event scenario. In some implementations, the user interface element 308 can be a selectable menu, a task bar, a webpage, or other container object for holding the content associated with the previously recorded event scenario. In some implementations, if multiple previously recorded scenarios are related to the current event scenario, multiple user interface elements can be presented, each for a different event scenario.

In this example, the content associated with the previously recorded event scenario that is presented on the mobile device 106 includes contact information 310 for the participants of the previous meeting and the person mentioned in the previous meeting (e.g., John White 302). In this example, the content presented also includes the audio and/or video recordings 312 of the previous meeting. Other content presented can include, for example, the documents 314 accessed during the previous meeting and the notes 316 taken during the previous meeting. In some implementations, the user of the mobile device can configure which types of the content are to be presented in the user interface element 308. In some implementations, only links to the content are presented.

In some implementations, in order to retrieve the information bundle associated with a previously recorded event scenario, the mobile device can submit a query with one or more of the subject matter, the location, the time, the participants, and/or other contextual cues from the current event scenario; and if the query matches the identifiers, functional, and descriptive labels for the corresponding elements in the information bundle of the previously recorded event scenario, then the information bundle for that previously recorded event scenario can be retrieved and presented on the mobile device during the current event scenario.

### Presenting Content in Response to Scenario-Based Queries

In addition to the automatic retrieval and presentation of content from a previously recorded event scenario during a subsequent, related event scenario, content associated with a recorded event scenario can also be presented in response to a scenario-based search query.

A scenario-based search query can be a search query containing terms that describe one or more aspects of the event scenario. Scenario-based search queries are helpful when the user wishes to retrieve documents that are relevant to a particular context embodied in the event scenario. For example, if the user has previously recorded event scenarios for several doctor's visits, and now wishes to retrieve the records obtained from all of those visits, the user can enter a search query that includes a functional label for the subject matter of the event scenarios (e.g., “doctor's visit”). The functional label can be used by the mobile device to identify the information bundles that have metadata containing this functional label. Once the information bundles are identified, content (e.g., documents and/or other data items) in these information bundles can be located (e.g., through the references or links or file identifiers in the information bundles) by the mobile device and presented to the user.

For another example, suppose the user has previously had a discussion with a friend about Global Warming, and an article was shared during the discussion. If an event scenario was created for this discussion, and if the user later wishes to retrieve this article, even if the user remembers nothing else about the article, the user can enter a search query that includes the identifier of the friend (e.g., the friend's name) and a functional label for the subject matter of the discussion (e.g., “global warming”). The mobile device can retrieve the information bundles that have metadata matching the search query, and the article or a link to the article should be present in these information bundles. If multiple information bundles are retrieved based on this search query (e.g., suppose the user has had several discussions about global warming with this friend), the user can further narrow the search by entering other contextual cues that he can recall about the particular discussion he wants to retrieve, such as the location of the discussion, the weather, any other subject matter mentioned during that discussion, any other people present at the discussion, the date of the discussion, and so on.

In some implementations, if information bundles of multiple scenarios are identified in response to a search query, distinguishing contextual cues about each of the information bundles can be presented to the user for selection. For example, if some of the identified information bundles are for events that occurred within the month, while others occurred several months ago, in addition, if some of these events occurred on a rainy day, while others occurred on a sunny day, these differentiating contextual cues can be presented to prompt the user to select a subset of information bundles. Because seeing these differentiating contextual cues may trigger new memories about the event that the user wishes to locate, likelihood of retrieving the correct information bundle containing the desired content (e.g., the article) can be increased. Once the user has selected an information bundle, the content (e.g., documents and other data items) referenced in the information bundle is made available to the user on the mobile device (e.g., in a designated folder or on the home screen of the mobile device).

Scenario-based queries are useful because it makes use of the sensory characterizations of many aspects of the scenario in which information is exchanged and recorded. Even though there may not be any logical connections between these sensory cues with the subject matter of the discussion or documents that are accessed during the scenario, because the brain tends to retain this information intuitively and subconsciously without much effort, these sensory characterizations can provide useful cues for retrieving information that are actually needed.

Using the scenario-based and automatic information bundling, categorization, retrieval, and presentation, the user is alleviated of the burden to manually categorize information and store it in a logical fashion. Nonetheless, the user is still free to do so on his or her own accord and continue to employ folder hierarchies to remember where files and documents are located and search and retrieve them using keywords search by filenames or content keywords. The scenario-based information bundling/categorization can be used to reduce the amount of time spent searching and locating each documents that are likely to be relevant to each event scenario.

### Other Example Event Scenarios

Scenario-base content categorization, retrieval, and presentation can be useful not only in many professional settings, but also personal and social settings. Each user can record event scenarios that are relevant to different aspects of his or her life.

For example, a student can record event scenarios for different classes, group discussion sessions, lab sessions, social gatherings, and extra-curricular projects that he or she participates in. Classes of the same subject, group study sessions the same project or homework assignment, class sessions and lab sessions of the same topic in a subject, social gatherings of the same group of friends, meetings and individual work of the same project can all form their respective sets of related event scenarios.

For another example, a professional can record event scenarios for different client meetings, team meetings, presentations, business pitches, client development meetings, seminars, and so on. Related event scenarios can be defined for each client and each matter handled for the client. Related event scenarios can also be defined by a target client that the user is actively pitching to at the moment. For example, each time the user meets with the target client, an information bundle can be automatically created for the occasion, and all information from previously recorded event scenarios that had this target client present would be retrieved and made available to the user on his mobile device.

The variety of event scenarios can be defined and recorded is virtually unlimited. In some implementations, each event scenario can potentially be related to multiple other event scenarios that are unrelated to one another. For example, one set of related event scenarios can be defined by the presence of a particular common participant, while another set of related event scenarios can be defined by the presence of the mobile device in a particular common location. In such cases, if the mobile device detects itself being in that particular common location and the presence of the particular common participant, information bundles for two sets of related event scenarios can be retrieved. The content from the two sets of related event scenarios can be presented for example under different headings or folders on the home screen of the mobile device.

### Building a Personal profile Based on Recorded Event Scenarios

In addition to recording and retrieving information bundles for individual event scenarios, as multiple event scenarios that occur over a period of time have been recorded, the recorded event scenarios can be synthesized to form a personal profile for the use. The personal profile can include descriptions of various routines performed by the user, including, for example, subject matter, location, time, participants, information accessed, and so on.

For example, a number of event scenarios can be recorded for a personal or professional routine activity that is performed by the user at different times. Each time the routine is performed, presumably the user visits the same location, maybe also at the same time of the day or on the same day of the week, meets with the same people, does the same set of things, and/or accesses the same set of information or content. The mobile device can identify these recurring elements in the event scenarios and conclude that these event scenarios are repeat occurrences of the same routine.

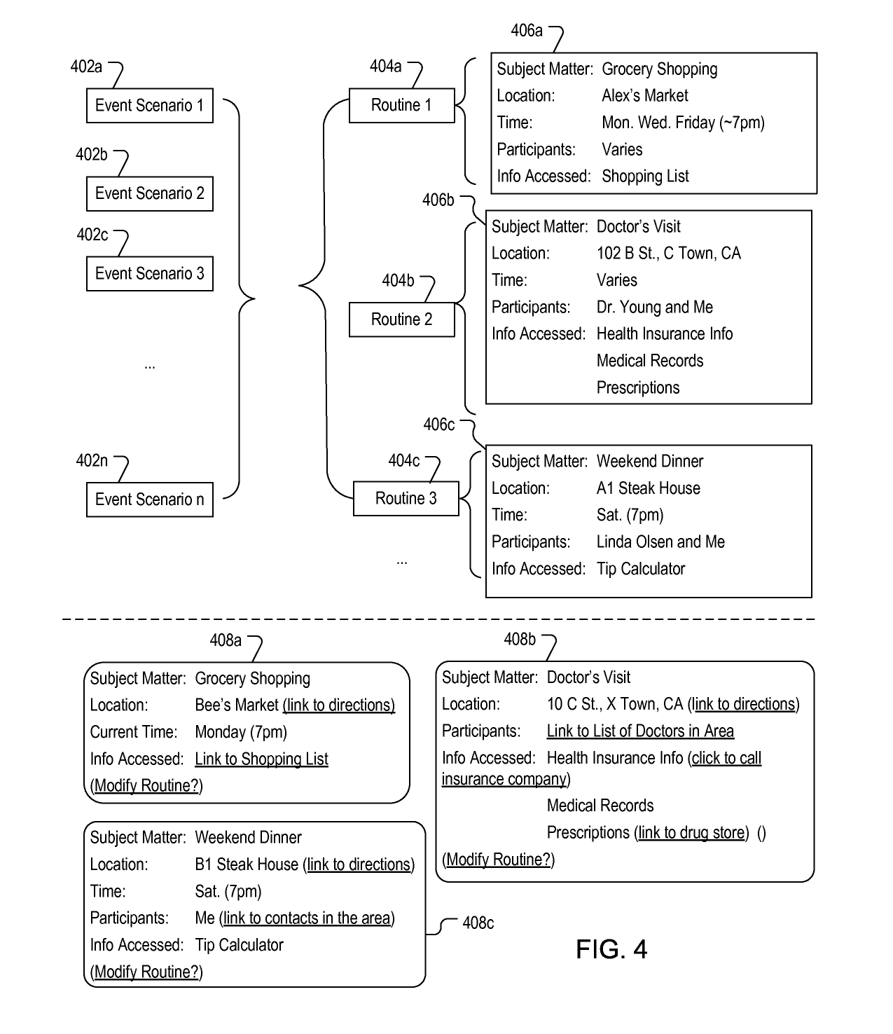

FIG. 4 illustrates a personal profile built according to a number of recorded event scenarios (e.g., 402a-402n) of a user. In this example, suppose that the user visits the neighborhood grocery store (e.g., Alex's Market) every Monday, Wednesday, and Friday in the evening and does grocery shopping for the items listed on a shopping list. Suppose that the user also visits the doctor's office from time to time and consult with Dr. Young when he is sick, and accesses his medical records, prescription records, and insurance information at the doctor's office. Further suppose that the user also have a weekend dinner date with a friend (e.g., Linda Olsen) at their favorite restaurant (e.g., A1 Steak House) every Saturday at 7 pm. At the end of the dinner, the user invokes the tip calculator application on the mobile device to calculate the tips for the dinner. Each of these event scenarios can be detected and recorded automatically by the mobile device that the user is carrying, and the metadata (e.g., identifiers, functional labels, and descriptive labels) associated with each of the above event scenarios reflects the above information about the routines (e.g., as shown in 406a-406c).

In this example, three routines (e.g., 404a-404c) can be derived from the recorded event scenarios (e.g., 404a-404c). In some implementation, each event scenario can belong to a routine, even if the routine only includes a single event scenario. In some implementations, routines are only created in the personal profile if there are a sufficient number of recorded event scenarios for the routine. In some implementations, information bundles of event scenarios in the same routine may be combined, and duplicate information is eliminated to save storage space. In such implementations, an event scenario in a routine can also be reconstructed from the information in the routine with the peculiarities specific to that event scenario.

In some implementations, when a new event scenario is detected and recorded, the mobile device compares the metadata for the newly recorded event scenarios with the metadata of existing event scenarios and/or existing routines, and determines whether the newly recorded event scenario is a repeat of an existing routine or if a new routine should be developed (e.g., when enough similar event scenarios have been recorded).

### Providing Information Based on the Personal Profile

In some implementations, information from the routines in the personal profile can be used to determine what information might be relevant to the user at specific times, locations, and/or in the presence of which persons. Following the example in FIG. 4, every Monday, Wednesday, and Friday around 7 pm, if the mobile device of the user detects that it is in the vicinity of Max's Market, the device would provide the shopping list to the user without any manual prompt from the user. If the mobile device of the user detects that it is in the doctor's office, it can provide the health insurance information, the medical records, and prescription records to the user (e.g., in a folder on the home screen of the mobile device) without any manual prompt from the user. On Saturday evenings, if the mobile device detects that it is still far from the A1 Steak House close to 7 pm, it can provide a reminder to the user about the dinner date, and if the mobile device detects that it is at the A1 Steak House, it can provide access to the tip calculator application to the user (e.g., as an icon on the home screen of mobile device even if normally the icon is located elsewhere).

In some implementations, the routines in the personal profile can also be used to determine what information might be relevant to the user given one or more detected contextual cues that are currently present at the moment. For example, when the mobile device detects that it is in proximity to Max's store, even though the time is noon, the mobile device can still provide the shopping list to the user in case the user might want to do the shopping earlier than usual. In some implementations, the mobile devices detects the contextual cues currently present (e.g., location, time, participants, whether, traffic, current schedule, and/or current activity of the user), and determines whether a routine is compatible with these contextual cues. If the routine is sufficiently compatible with the currently detected contextual cues, information relevant to the routine can be provided to the user on the mobile device without manual request from the user. Sufficient compatibility can be configured by the user, for example, by specifying which contextual cues do not have to be strictly adhered for a routine, and how many contextual cues should be present before the automatic presentation of information is triggered.

In some implementations, when the user completely changes their geographical area that he or she is located in (e.g., when the user goes to a different part of town, a different city, or a different country), the routines in the user's personal profile can be used to generate a set of new information to help the user adapt the old routines to the new environment.

For example, if the user has moved from “C Town, CA” to “X Town, CA,” the mobile device may search the local area to find a grocery store (e.g., “Bee's Market”) that is comparable to the grocery store (“Alex's Market”) in the original grocery shopping routine 406a. The comparable store may be selected based on a number of factors such as distance, style, price range, and so on. At the usual times for the grocery shopping routine, the mobile device can provide user interface element 408a that shows the newly suggested shopping location, direction to the new location, the usual shopping list, and a link to a user interface for modifying this routine.

In addition, in some implementations, the mobile device allows the user to edit the routines in his personal profile directly. For example, after the mobile device detects that the user has moved to “X Town, CA,” it automatically makes a recommendation for a new doctor's office for the user (e.g., based on the insurance company's coverage). When the user opens this routine in the personal profile, user interface element 408b can be presented to show the recommendation and a link to the driving directions for the new doctor's office. Furthermore, links to a listing of doctors in the area, new prescription drug stores, and click-to-call link to the insurance company can be provided on the user interface element 408b as well. The user can modify each aspect of this routine manually by invoking a “Modify Routine” link on the user interface element 408b.

Similarly, for the weekend dinner date routine, user interface element 408c for an alternative routine can be presented to the user at appropriate times. For example, a comparable restaurant (or a completely different type of restaurant, depending on user's configuration) can be suggested as the location for this alternative routine. In addition, since this dinner routine involves other people (e.g., Linda Olsen) who is presumable not in this geographical area, a link to a list of contacts in this area can be presented on the user interface element 408c.

Other configurations of a routine are possible. For example, other contextual cues can be included in the definitions of a routine, and each routine does not have to have the same set of elements (e.g., subject matter, location, time, participants, information accessed, weather, etc.). In some implementations, suggested modifications to the routines can be generated based on factors other than an overall change of geographical location. For example, one or more routines can be associated with a mood, and when the user resets an indicator for his mood on the mobile device, a modified routine can be presented based on the currently selected mood.

### Example Processes for Scenario-Based Content Categorization, Retrieval, and Presentation

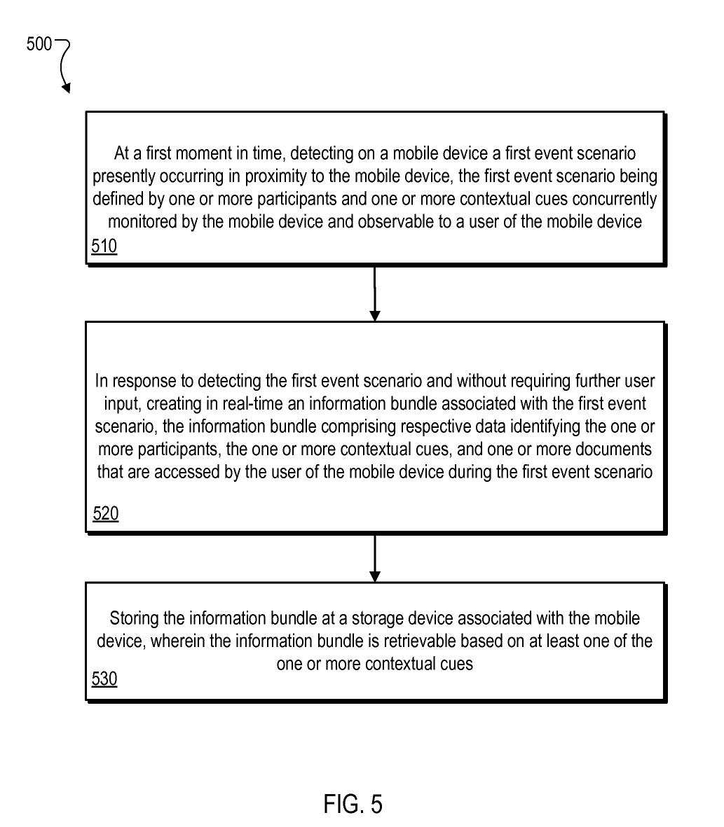

FIG. 5 is a flow diagram of an example process 500 for scenario-based content categorization.

The example process 500 starts at a first moment in time, when a first event scenario presently occurring in proximity to the mobile device is detected on the mobile device (510). The first event scenario can be defined by one or more participants and one or more contextual cues concurrently monitored by the mobile device and observable to a user of the mobile device. In response to detecting the first event scenario and without requiring further user input, an information bundle associated with the first event scenario can be created in real time (520). The information bundle includes respective data identifying the one or more participants, the one or more contextual cues, and one or more documents that are accessed by the user of the mobile device during the first event scenario. The information bundle can then be stored at a storage device associated with the mobile device, wherein the information bundle is retrievable based on at least one of the one or more contextual cues (530).

In some implementations, to detect the first event scenario, first user input can be received on a touch-sensitive display, where the first user input indicates a start of the first event scenario. In some implementations, to detect the first event scenario, first user input can be received on a touch-sensitive display, where the first user input indicates an end of the first event scenario. In some implementations, to detect the first event scenario, a current location of the mobile device can be determined by the mobile device; a current time can be determined by the mobile device; and a notification of a scheduled calendar event can be received on the mobile device, where the notification indicates an imminent start of the scheduled calendar event at the current location of the mobile device. In some implementation, to detect the first event scenario, a current time can be determined on the mobile device; one or more persons present in proximity to the mobile device can be identified by the mobile device; and a notification of a scheduled calendar event can be received on the mobile device, where the notification indicates an imminent start of the scheduled calendar event and that the identified one or more persons are participants of the scheduled calendar event.

In some implementations, the one or more contextual cues concurrently monitored by the mobile device and observable to a user of the mobile device can include one or more of a current location, a current time, and a sensory characterization of an environment surrounding the mobile device. In some implementations, the sensory characterization of the environment surrounding the mobile device can include one or more of a temperature reading, a weather report, identification of a visual landmark present in the environment, and identification of an audio landmark present in the environment.

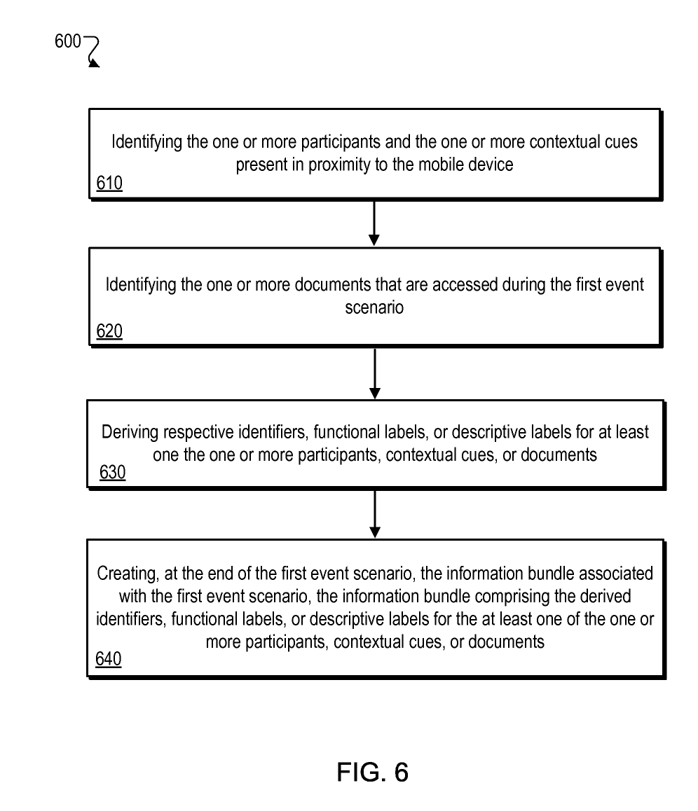

FIG. 6 is a flow diagram of an example process 600 for creating an information bundle for an event scenario.

In some implementations, to create in real-time an information bundle in association with the first event scenario, the one or more participants and the one or more contextual cues present in proximity to the mobile device can be identified (610). The one or more documents that are accessed during the first event scenario can also be identified (620). Then, respective identifiers, functional labels, and descriptive labels for at least one the one or more participants, contextual cues, and documents can be derived (630). And at the end of the first event scenario, the information bundle associated with the first event scenario can be created (640), where the information bundle includes the derived identifiers, functional labels, and descriptive labels for the at least one of the one or more participants, contextual cues, and documents.

In some implementations, the information bundle can further include content copied from the one or more documents and content recorded during the first event scenario.

In some implementations, to store the information bundle at a storage device associated with the mobile device, the information bundle can be sent to a server in communication with the mobile device, where the server stores the information bundle.

In some implementations, the information bundle can be enriched by the server with additional information received from respective mobile devices associated with the one or more participants of the first event scenario.

In some implementations, information can be received from respective mobile devices associated with the one or more participants, and the information bundle is enriched with the received information.

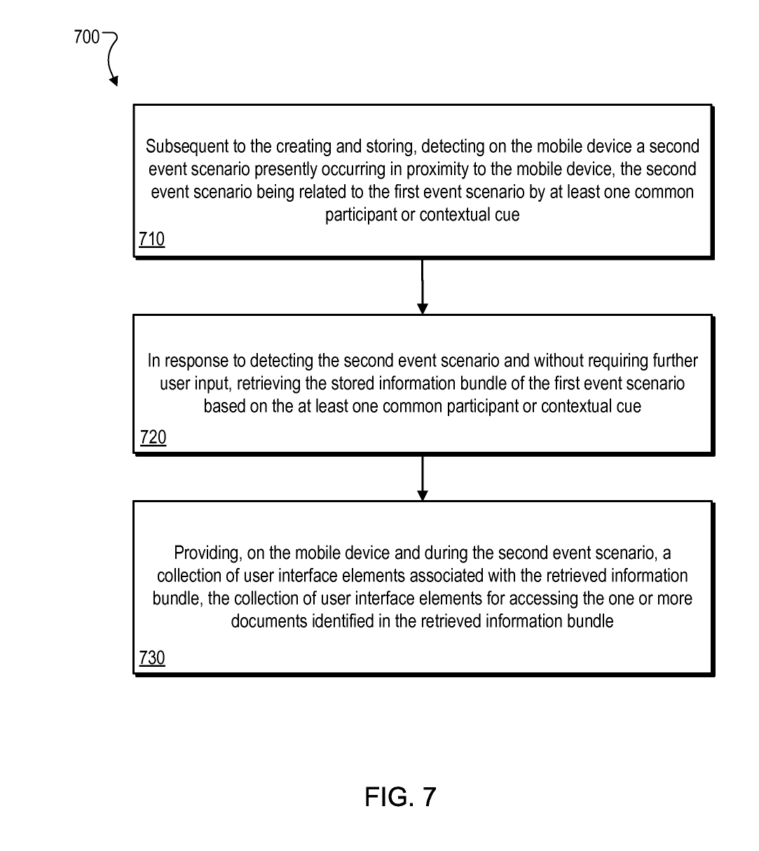

FIG. 7 is a flow diagram of an example process 700 for presenting content during a subsequent, related event scenario.

The process 700 starts subsequent to the creating and storing steps of the example process 500, first, a second event scenario presently occurring in proximity to the mobile device can be detected on the mobile device (710), where the second event scenario is related to the first event scenario by at least one common participant or contextual cue. In response to detecting the second event scenario and without requiring further user input, the stored information bundle of the first event scenario can be retrieved based on the at least one common participant or contextual cue (720). Then, on the mobile device and during the second event scenario, a collection of user interface elements associated with the retrieved information bundle can be provided (730), where the collection of user interface elements are for accessing the one or more documents identified in the retrieved information bundle.

In some implementations, the first event scenario can be associated with a first scheduled calendar event, while the second event can be associated with a second scheduled calendar event related to the first calendar event.

In some implementations, the collection of user interface elements can be a collection of links to the one or more documents and can be presented on a home screen of a touch-sensitive display of the mobile device.

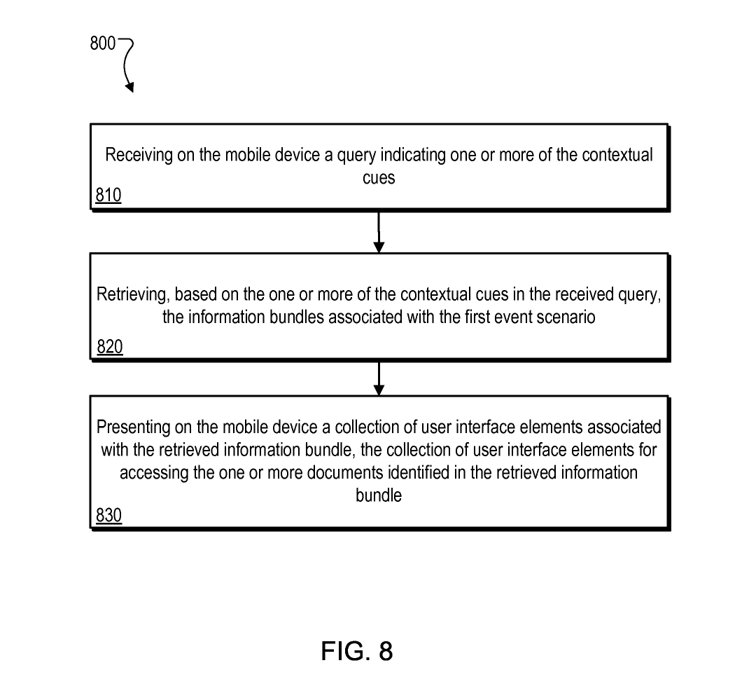

FIG. 8 is a flow diagram of an example process 800 for presenting content in response to a query using contextual cues present in an event scenario.

In some implementations, the process 800 starts when a query indicating one or more of the contextual cues is received on the mobile device (810). Then, the information bundles associated with the first event scenario can be retrieved based on the one or more of the contextual cues in the received query (820). Then, a collection of user interface elements associated with the retrieved information bundle can be provided on the mobile device (830), where the collection of user interface elements is for accessing the one or more documents identified in the retrieved information bundle.

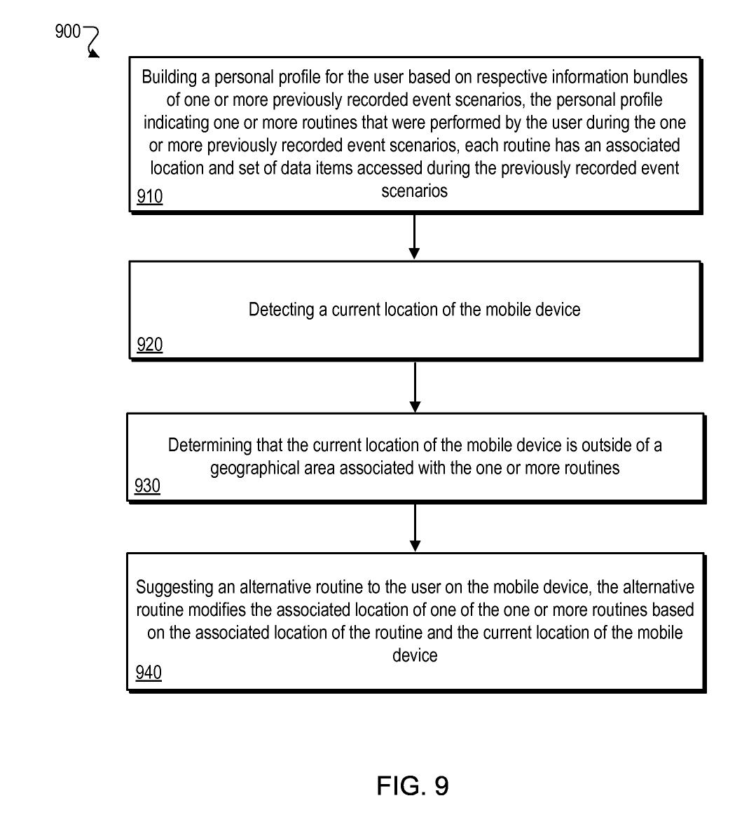

FIG. 9 is a flow diagram of an example process 900 for building a personal profile and presenting content based on the personal profile.

In some implementations, the process 900 starts when a personal profile is built for the user based on respective information bundles of one or more previously recorded event scenarios (910), where the personal profile indicates one or more routines that were performed by the user during the one or more previously recorded event scenarios, and each routine has an associated location and set of data items accessed during the previously recorded event scenarios. Subsequently, a current location of the mobile device can be detected by the mobile device (920). Then the mobile device determines that the current location of the mobile device is outside of a geographical area associated with the one or more routines (930). Upon such determination, the mobile device can suggest an alternative routine to the user (940), where the alternative routine modifies the associated location of one of the one or more routines based on the associated location of the routine and the current location of the mobile device.

### Example Mobile Device

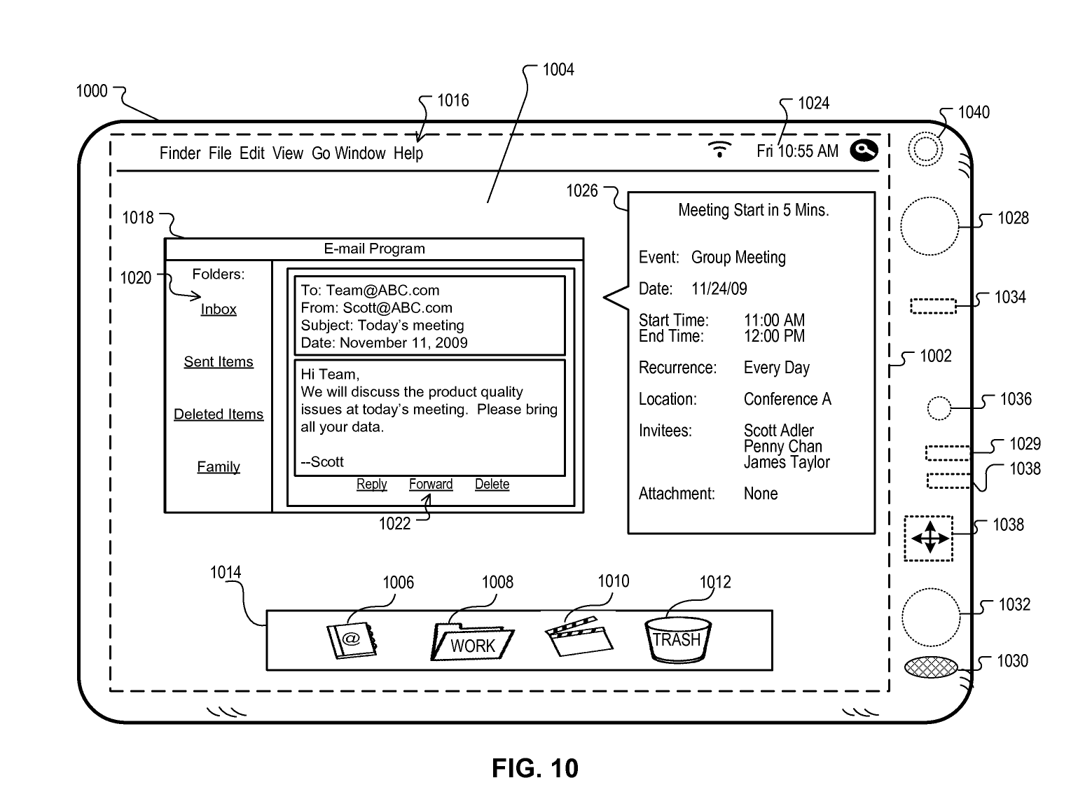

FIG. 10 is a block diagram of example mobile device 1000. The mobile device 1000 can be, for example, a tablet device, a handheld computer, a personal digital assistant (PDA), a cellular telephone, a network appliance, a digital camera, a smart phone, an enhanced general packet radio service (EGPRS) mobile phone, a network base station, a media player, a navigation device, an email device, a game console, or a combination of any two or more of these data processing devices or other data processing devices.

### Mobile Device Overview

In some implementations, the mobile device 1000 includes a touch-sensitive display 1002. The touch-sensitive display 1002 can be implemented with liquid crystal display (LCD) technology, light emitting polymer display (LPD) technology, or some other display technology. The touch-sensitive display 1002 can be sensitive to haptic and/or tactile contact with a user. In addition, the device 1000 can include a touch-sensitive surface (e.g., a trackpad, or a touchpad).

In some implementations, the touch-sensitive display 1002 can be multi-touch-sensitive display. The multi-touch-sensitive display 1002 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device.

A user can interact with the device 1000 using various inputs. Example inputs include touch inputs and gesture inputs. A touch input is an input where a user holds his or her finger (or other input tool) at a particular location. A gesture input is an input where a user moves his or her finger (or other input tool). An example gesture input is a swipe input, where a user swipes his or her finger (or other input tool) across the screen of the touch-sensitive display 1002. In some implementations, the device can detect inputs that are received in direct contact with the display 1002, or that are received within a particular vertical distance of the display 1002 (e.g., within one or two inches of the display 1002). Users can simultaneously provide input at multiple locations on the display 1002. For example, inputs simultaneously touching at two or more locations can be received.

In some implementations, the mobile device 1000 can display one or more graphical user interfaces (e.g., user interface 1004) on the touch-sensitive display 1002 for providing the user access to various system objects and for conveying information to the user. In some implementations, the graphical user interface 1004 can include one or more display objects that represent system objects including various device functions, applications, windows, files, alerts, events, or other identifiable system objects. In this particular example, the graphical user interface 1004 includes display object 1006 for an address book application, display object 1008 for a file folder named “work”, display object 1010 for a camera function on the device 1000, and display object 1012 for a destination for deleted files (e.g., a “trash can”). Other display objects are possible.

In some implementations, the display objects can be configured by a user, e.g., a user may specify which display objects are displayed, and/or may download additional applications or other software that provides other functionalities and corresponding display objects. In some implementations, the display objects can be dynamically generated and presented based on the current context and inferred needs of the user. In some implementations, the currently presented display objects can be grouped in a container object, such as a task bar 1014.

### Example Mobile Device Functionality

In some implementations, the mobile device 1000 can implement multiple device functionalities, such as a telephony device; an e-mail device; a map device; a WiFi base station device; and a network video transmission and display device. As part of one or more of these functionalities, the device 1000 can present graphical user interfaces on the touch-sensitive display 1002 of the mobile device, and also responds to input received from a user, for example, through the touch-sensitive display 1002. For example, a user can invoke various functionalities by launching one or more programs on the device. A user can invoke a functionality, for example, by touching one of the display objects in the task bar 1014 of the device. Touching the display object 1006 can invoke the address book application on the device for accessing stored contact information. A user can alternatively invoke particular functionality in other ways including, for example, using one of the use-selectable menus 1016 included in the user interface 1004. In some implementations, particular functionalities are automatically invoked according to the current context or inferred needs of the user as determined automatically and dynamically by the mobile device 1000, for example, as described in herein.

Once a program has been selected, one or more windows or pages corresponding to the program can be displayed on the display 1002 of the device 1000. A user can navigate through the windows or pages by touching appropriate locations on the display 1002. For example, the window 1018 corresponds to an email application. The user can interact with the window 1018 using touch input much as the user would interact with the window using mouse or keyboard input. For example, the user can navigate through various folders in the email program by touching one of the user selectable controls 1020 corresponding to the folders listed in the window 1018. As another example, a user can specify that he or she wises to reply, forward, or delete the current e-mail by touching one of the user-selectable controls 1022 on the display.

In some implementations, notifications can be generated by the operating system or applications residing on the mobile device 1000. For example, the device 1000 can include internal clock 1024, and notification window 1026 of a scheduled calendar event can be generated by a calendar application and presented on the user interface 1004 at a predetermined time (e.g., 5 minutes) before the scheduled time of the calendar event. The notification window 1026 can include information about the scheduled calendar event (e.g., a group meeting), such as the amount of time remaining before the start of the event, the subject of the event, the start and end times of the event, the recurrence frequency of the event, the location of the event, the invitees or participants of the event, and any additional information relevant to the event (e.g., an attachment). In some implementations, a user can interact with the notification window to invoke the underlying application, such as by touching the notification window 1026 on the touch-sensitive display 1002.

In some implementations, upon invocation of a device functionality, the graphical user interface 1004 of the mobile device 1000 changes, or is augmented or replaced with another user interface or user interface elements, to facilitate user access to particular functions associated with the corresponding device functionality.

In some implementations, the mobile device 1000 can implement network distribution functionality. For example, the functionality can enable the user to take the mobile device 1000 and provide access to its associated network while traveling. In particular, the mobile device 1000 can extend Internet access (e.g., WiFi) to other wireless devices in the vicinity. For example, the mobile device 1000 can be configured as a base station for one or more devices. As such, the mobile device 1000 can grant or deny network access to other wireless devices.

In some implementations, the mobile device 1000 may include circuitry and sensors for supporting a location determining capability, such as that provided by the global positioning system (GPS) or other positioning systems (e.g., systems using WiFi access points, television signals, cellular grids, Uniform Resource Locators (URLs)). In some implementations, a positioning system (e.g., GPS receiver 1028) can be integrated into the mobile device 1000 or provided as a separate device that is coupled to the mobile device 1000 through an interface (e.g., port device 1029) to provide access to location-based services. In some implementations, the positioning system can provide more accurate positioning within a building structure, for example, using sonar technologies.

In some implementations, the mobile device 1000 can include a location-sharing functionality. The location-sharing functionality enables a user of the mobile device to share the location of the mobile device with other users (e.g., friends and/or contacts of the user).

In some implementations, the mobile device 1000 can include one or more input/output (I/O) devices and/or sensor devices. For example, speaker 1030 and microphone 1032 can be included to facilitate voice-enabled functionalities, such as phone and voice mail functions.

In some implementations, proximity sensor 1034 can be included to facilitate the detection of the proximate (or distance) of the mobile device 1000 to a user of the mobile device 1000. Other sensors can also be used. For example, in some implementations, ambient light sensor 1036 can be utilized to facilitate adjusting the brightness of the touch-sensitive display 1002. In some implementations, accelerometer 1038 can be utilized to detect movement of the mobile device 1000, as indicated by the directional arrows.

In some implementations, the port device 1029, e.g., a Universal Serial Bus (USB) port, or a docking port, or some other wired port connection, can be included. The port device 1029 can, for example, be utilized to establish a wired connection to other computing devices, such as other communication devices, network access devices, a personal computer, a printer, a display screen, or other processing devices capable of receiving and/or transmitting data. In some implementations, the port device 1029 allows the mobile device 1000 to synchronize with a host device using one or more protocols, such as, for example, the TCP/IP, HTTP, UDP and any other known protocol.

The mobile device 1000 can also include one or more wireless communication subsystems, such as 802.11b/g communication device 1038, and/or Bluetooth™ communication device 1088. Other communication protocols can also be supported, including other 802.x communication protocols (e.g., WiMax, WiFi, 3G), code division multiple access (CDMA), global system for mobile communications (GSM), Enhanced Data GSM Environment (EDGE), etc.

In some implementations, the mobile device 1000 can also include camera lens and sensor 1040. The camera lens and sensor 1040 can capture still images and/or video. In some implementations, the camera lens can be a bi-directional lens capable of capturing objects facing either or both sides of the mobile device. In some implementations, the camera lens is an omni-directional lens capable of capturing objects in all directions of the mobile device.

### Example Network Operating Environment

FIG. 11 is a block diagram 1100 of an example of a mobile device operating environment. The mobile device 1000 of FIG. 10 (shown as 1000a or 1000b here) can, for example, communicate over one or more wired and/or wireless networks 1110 in data communication. For example, wireless network 1112 (e.g., a cellular network), can communicate with wide area network (WAN) 1114, such as the Internet, by use of gateway 1116. Likewise, access device 1118, such as an 802.11g wireless access device, can provide communication access to the wide area network 1114. In some implementations, both voice and data communications can be established over the wireless network 1112 and the access device 1118. For example, the mobile device 1000a can place and receive phone calls (e.g., using VoIP protocols), send and receive e-mail messages (e.g., using POP3 protocol), and retrieve electronic documents and/or streams, such as web pages, photographs, and videos, over the wireless network 1112, gateway 1116, and wide area network 1114 (e.g., using TCP/IP or UDP protocols). Likewise, in some implementations, the mobile device 1000b can place and receive phone calls, send and receive e-mail messages, and retrieve electronic documents over the access device 1118 and the wide area network 1114. In some implementations, the mobile device 1000b can be physically connected to the access device 1118 using one or more cables and the access point 1118 can be a personal computer. In this configuration, the mobile device 1000 can be referred to as a “tethered” device.

The mobile devices 1000a and 1000b can also establish communications by other means (e.g., wireless communications). For example, the mobile device 1000a can communicate with other mobile devices (e.g., other wireless devices, cell phones, etc.), over the wireless network 1112. Likewise, the mobile devices 1000a and 1000b can establish peer-to-peer communications 1120 (e.g., a personal area network), by use of one or more communication subsystems (e.g., a Bluetooth™ communication device). Other communication protocols and topologies can also be implemented.

The mobile device 1000a or 1000b can, for example, communicate with one or more services (not shown) over the one or more wired and/or wireless networks 1110. For example, navigation service 1130 can provide navigation information (e.g., map information, location information, route information, and other information), to the mobile device 1000a or 1000b. Access to a service can be provided by invocation of an appropriate application or functionality on the mobile device. For example, to invoke the navigation service 1130, a user can invoke a Maps function or application by touching the Maps object. Messaging service 1140 can, for example, provide e-mail and/or other messaging services. Media service 1150 can, for example, provide access to media files, such as song files, movie files, video clips, and other media data. Syncing service 1160 can, for example, perform syncing services (e.g., sync files). Content service 1170 can, for example, provide access to content publishers such as news sites, RSS feeds, web sites, blogs, social networking sites, developer networks, etc. Data organization and retrieval service 1180 can, for example, provide scenario-based content organization and retrieval service to mobile devices, and store information bundles and other information for the event scenarios (e.g., in database 1190). Other services can also be provided, including a software update service that automatically determines whether software updates exist for software on the mobile device, then downloads the software updates to the mobile device where it can be manually or automatically unpacked and/or installed. Other services such as location-sharing services can also be provided.

### Example Mobile Device Architecture

FIG. 12 is a block diagram 1200 of an example implementation of the mobile device 1000 of FIG. 1. The mobile device 1000 can include memory interface 1202, one or more data processors, image processors and/or central processing units 1204, and peripherals interface 1206. The memory interface 1202, the one or more processors 1204 and/or the peripherals interface 1206 can be separate components or can be integrated in one or more integrated circuits. The various components in the mobile device 1000 can be coupled by one or more communication buses or signal lines.

Sensors, devices, and subsystems can be coupled to the peripherals interface 1206 to facilitate multiple functionalities. For example, motion sensor 1210, light sensor 1212, and proximity sensor 1214 can be coupled to the peripherals interface 1206 to facilitate orientation, lighting, and proximity functions. For example, in some implementations, the light sensor 1112 can be utilized to facilitate adjusting the brightness of the touch screen 1246. In some implementations, the motion sensor 1210 can be utilized to detect movement of the device.

Other sensors 1216 can also be connected to the peripherals interface 1206, such as a positioning system (e.g., GPS receiver), a temperature sensor, a biometric sensor, or other sensing device, to facilitate related functionalities.

For example the device 1200 can receive positioning information from positioning system 1232. The positioning system 1232, in various implementations, can be a component internal to the device 1200, or can be an external component coupled to the device 1200 (e.g., using a wired connection or a wireless connection). In some implementations, the positioning system 1232 can include a GPS receiver and a positioning engine operable to derive positioning information from received GPS satellite signals. In other implementations, the positioning system 1232 can include a compass (e.g., a magnetic compass), a gyro and an accelerometer, as well as a positioning engine operable to derive positioning information based on dead reckoning techniques. In still further implementations, the positioning system 1232 can use wireless signals (e.g., cellular signals, IEEE 802.11 signals) to determine location information associated with the device. Other positioning systems are possible.

Other positioning systems and technologies can be implemented on, or coupled to the mobile device to allow the mobile device to self-locate. In some implementations, precision of location determination can be improved to include altitude information. In some implementations, the precision of location determination can be improved. For example, a user's exact location may be determined within building structures using sonar technologies. In such implementations, building structure information may be obtained through a server of such information.

Broadcast reception functions can be facilitated through one or more radio frequency (RF) receiver(s) 1218. An RF receiver can receive, for example, AM/FM broadcast or satellite broadcasts (e.g., XM® or Sirius® radio broadcast). An RF receiver can also be a TV tuner. In some implementations, The RF receiver 1218 is built into the wireless communication subsystems 1224. In other implementations, the RF receiver 1218 is an independent subsystem coupled to the device 1200 (e.g., using a wired connection or a wireless connection). The RF receiver 1218 can include a Radio Data System (RDS) processor, which can process broadcast content and simulcast data (e.g., RDS data). In some implementations, the RF receiver 1218 can be digitally tuned to receive broadcasts at various frequencies. In addition, the RF receiver 1218 can include a scanning function which tunes up or down and pauses at a next frequency where broadcast content is available.

Camera subsystem 1220 and optical sensor 1222 (e.g., a charged coupled device (CCD) or a complementary metal-oxide semiconductor (CMOS) optical sensor), can be utilized to facilitate camera functions, such as recording photographs and video clips.

Communication functions can be facilitated through one or more wireless communication subsystems 1224, which can include radio frequency receivers and transmitters and/or optical (e.g., infrared) receivers and transmitters. Wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving and/or transmitting data. The specific design and implementation of the communication subsystem 1224 can depend on the communication network(s) over which the mobile device 100 is intended to operate. For example, a mobile device 1000 may include wireless communication subsystems 1224 designed to operate over a GSM network, a GPRS network, an EDGE network, 802.x communication networks (e.g., WiFi, WiMax, or 3G networks), code division multiple access (CDMA) and a Bluetooth™ network. The wireless communication subsystems 1224 may include hosting protocols such that the device 1200 may be configured as a base station for other wireless devices. As another example, the communication subsystems can allow the device to synchronize with a host device using one or more protocols, such as, for example, the TCP/IP protocol, HTTP protocol, UDP protocol, and any other known protocol.

Audio subsystem 1226 can be coupled to speaker 1228 and one or more microphones 1230 to facilitate voice-enabled functions, such as voice recognition, voice replication, digital recording, and telephony functions.

I/O subsystem 1240 can include touch screen controller 1242 and/or other input controller(s) 1244. The touch-screen controller 1242 can be coupled to touch screen 1246. The touch screen 1246 and touch screen controller 1242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 1246.

The other input controller(s) 1244 can be coupled to other input/control devices 1248, such as one or more buttons, rocker switches, thumb-wheel, infrared port, USB port, and/or a pointer device such as a stylus. The one or more buttons (not shown) can include an up/down button for volume control of the speaker 1228 and/or the microphone 1230.

In one implementation, a pressing of the button for a first duration may disengage a lock of the touch screen 1246; and a pressing of the button for a second duration that is longer than the first duration may turn power to the mobile device 1200 on or off. The user may be able to customize a functionality of one or more of the buttons. The touch screen 1246 can, for example, also be used to implement virtual or soft buttons and/or a keypad or keyboard.

In some implementations, the mobile device 1200 can present recorded audio and/or video files, such as MP3, AAC, and MPEG files. In some implementations, the mobile device 1200 can include the functionality of an MP3 player, such as an iPod™. The mobile device 1200 may, therefore, include a dock connector that is compatible with the iPod™. Other input/output and control devices can also be used.

The memory interface 1202 can be coupled to memory 1250. The memory 1250 can include high-speed random access memory and/or non-volatile memory, such as one or more magnetic disk storage devices, one or more optical storage devices, and/or flash memory (e.g., NAND, NOR). The memory 1250 can store an operating system 1252, such as Darwin, RTXC, LINUX, UNIX, OS X, WINDOWS, or an embedded operating system such as VxWorks. The operating system 1252 may include instructions for handling basic system services and for performing hardware dependent tasks. In some implementations, the operating system 1252 can be a kernel (e.g., UNIX kernel).

The memory 1250 may also store communication instructions 1254 to facilitate communicating with one or more additional devices, one or more computers and/or one or more servers. The communication instructions 1254 can also be used to select an operational mode or communication medium for use by the device, based on a geographical location (e.g., obtained by the GPS/Navigation instructions 1268) of the device. The memory 1250 may include graphical user interface instructions 1256 to facilitate graphic user interface processing; sensor processing instructions 1258 to facilitate sensor-related processing and functions; phone instructions 1260 to facilitate phone-related processes and functions; electronic messaging instructions 1262 to facilitate electronic-messaging related processes and functions; web browsing instructions 1864 to facilitate web browsing-related processes and functions; media processing instructions 1266 to facilitate media processing-related processes and functions; GPS/Navigation instructions 1268 to facilitate GPS and navigation-related processes and instructions; camera instructions 1270 to facilitate camera-related processes and functions; and/or other icon process instructions 1272 to facilitate processes and functions; and/or other software instructions 1272 to facilitate other processes and functions, e.g., security processes and functions, device customization processes and functions (based on predetermined user preferences), and other software functions. The memory 1250 may also store other software instructions (not shown), such as web video instructions to facilitate web video-related processes and functions; and/or web shopping instructions to facilitate web shopping-related processes and functions. In some implementations, the media processing instructions 1266 are divided into audio processing instructions and video processing instructions to facilitate audio processing-related processes and functions and video processing-related processes and functions, respectively. An activation record and International Mobile Equipment Identity (IMEI) 1274 or similar hardware identifier can also be stored in memory 1250.

Each of the above identified instructions and applications can correspond to a set of instructions for performing one or more functions described above. These instructions need not be implemented as separate software programs, procedures, or modules. The memory 1250 can include additional instructions or fewer instructions. Furthermore, various functions of the mobile device 1200 may be implemented in hardware and/or in software, including in one or more signal processing and/or application specific integrated circuits.

The features described can be implemented in digital electronic circuitry, or in computer hardware, firmware, software, or in combinations of them. The features can be implemented in a computer program product tangibly embodied in an information carrier, e.g., in a machine-readable storage device or in a composition of matter capable of effecting a propagated signal, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an Application Programming Interface (API). An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method, comprising:
at a first moment in time, detecting on a mobile device a first event scenario presently occurring in proximity to the mobile device, the first event scenario being defined by one or more participants and one or more contextual cues concurrently monitored by the mobile device and observable to a user of the mobile device;
in response to detecting the first event scenario and without requiring further user input, creating in real-time an information bundle associated with the first event scenario, the information bundle comprising respective data identifying the one or more participants, the one or more contextual cues, and one or more documents that are accessed by the user of the mobile device during the first event scenario; and
storing the information bundle at a storage device associated with the mobile device, wherein the information bundle is retrievable based on at least one of the one or more contextual cues.

2. The method of claim 1, wherein detecting the first event scenario further comprises:
receiving first user input on a touch-sensitive display, the first user input indicating a start of the first event scenario.

3. The method of claim 1, wherein detecting the first event scenario further comprises:
receiving first user input on a touch-sensitive display, the first user input indicating an end of the first event scenario.

4. The method of claim 1, wherein detecting the first event scenario further comprises:
determining a current location of the mobile device;
determining a current time; and
receiving on the mobile device notification of a scheduled calendar event, the notification indicating an imminent start of the scheduled calendar event at the current location of the mobile device.

5. The method of claim 1, wherein detecting the first event scenario further comprises:
determining a current time;
identifying one or more persons present in proximity to the mobile device; and
receiving on the mobile device notification of a scheduled calendar event, the notification indicating an imminent start of the scheduled calendar event and that the identified one or more persons are participants of the scheduled calendar event.

6. The method of claim 1, wherein the one or more contextual cues concurrently monitored by the mobile device and observable to a user of the mobile device include one or more of a current location, a current time, and a sensory characterization of an environment surrounding the mobile device.

7. The method of claim 6, wherein the sensory characterization of the environment surrounding the mobile device includes one or more of a temperature reading, a weather report, identification of a visual landmark present in the environment, and identification of an audio landmark present in the environment.

8. The method of claim 1, wherein creating in real-time an information bundle in association with the first event scenario further comprises:
identifying the one or more participants and the one or more contextual cues present in proximity to the mobile device;
identifying the one or more documents that are accessed during the first event scenario;
deriving respective identifiers, functional labels, or descriptive labels for at least one the one or more participants, contextual cues, or documents; and
creating, at the end of the first event scenario, the information bundle associated with the first event scenario, the information bundle comprising the derived identifiers, functional labels, or descriptive labels for the at least one of the one or more participants, contextual cues, or documents.

9. The method of claim 8, wherein the information bundle further includes content copied from the one or more documents and content recorded during the first event scenario.

10. The method of claim of claim 1, wherein storing the information bundle at a storage device associated with the mobile device comprises:
sending the information bundle to a server in communication with the mobile device, where the server stores the information bundle.

11. The method of claim 10, wherein the information bundle is enriched by the server with additional information received from respective mobile devices associated with the one or more participants of the first event scenario.

12. The method of claim 1, further comprising:
receiving information from respective mobile devices associated with the one or more participants; and
enriching the information bundle with the received information.

13. The method of claim 1, further comprising:
subsequent to the creating and storing, detecting on the mobile device a second event scenario presently occurring in proximity to the mobile device, the second event scenario being related to the first event scenario by at least one common participant or contextual cue;
in response to detecting the second event scenario and without requiring further user input, retrieving the stored information bundle of the first event scenario based on the at least one common participant or contextual cue; and
providing, on the mobile device and during the second event scenario, a collection of user interface elements associated with the retrieved information bundle, the collection of user interface elements for accessing the one or more documents identified in the retrieved information bundle.

14. The method of claim 13, wherein the first event scenario is associated with a first scheduled calendar event, and the second event is associated with a second scheduled calendar event related to the first calendar event.

15. The method of claim 13, wherein the collection of user interface elements is a collection of links to the one or more documents and is presented on a home screen of a touch-sensitive display of the mobile device.

16. The method of claim 1, further comprising:
receiving on the mobile device a query indicating one or more of the contextual cues;
retrieving, based on the one or more of the contextual cues in the received query, the information bundles associated with the first event scenario; and
presenting on the mobile device a collection of user interface elements associated with the retrieved information bundle, the collection of user interface elements for accessing the one or more documents identified in the retrieved information bundle.

17. The method of claim 1, further comprising:
building a personal profile for the user based on respective information bundles of one or more previously recorded event scenarios, the personal profile indicating one or more routines that were performed by the user during the one or more previously recorded event scenarios, each routine has an associated location and set of data items accessed during the previously recorded event scenarios;
detecting a current location of the mobile device;
determining that the current location of the mobile device is outside of a geographical area associated with the one or more routines; and
suggesting an alternative routine to the user on the mobile device, where the alternative routine modifies the associated location of one of the one or more routines based on the associated location of the routine and the current location of the mobile device.

18. A computer-readable medium having instructions stored thereon, which, when executed by one or more processors, cause the one or more processors to perform operations comprising:
at a first moment in time, detecting on a mobile device a first event scenario presently occurring in proximity to the mobile device, the first event scenario being defined by one or more participants and one or more contextual cues concurrently monitored by the mobile device and observable to a user of the mobile device;
in response to detecting the first event scenario and without requiring further user input, creating in real-time an information bundle associated with the first event scenario, the information bundle comprising respective data identifying the one or more participants, the one or more contextual cues, and one or more documents that are accessed by the user of the mobile device during the first event scenario; and
storing the information bundle at a storage device associated with the mobile device, wherein the information bundle is retrievable based on at least one of the one or more contextual cues.

19. The computer-readable medium of claim 18, wherein creating in real-time an information bundle in association with the first event scenario further comprises:
identifying the one or more participants and the one or more contextual cues present in proximity to the mobile device;
identifying the one or more documents that are accessed during the first event scenario;
deriving respective identifiers, functional labels, or descriptive labels for at least one the one or more participants, contextual cues, or documents; and
creating, at the end of the first event scenario, the information bundle associated with the first event scenario, the information bundle comprising the derived identifiers, functional labels, and descriptive labels for the at least one of the one or more participants, contextual cues, or documents.

20. The computer-readable medium of claim 18, wherein the operations further comprise:
subsequent to the creating and storing, detecting on the mobile device a second event scenario presently occurring in proximity to the mobile device, the second event scenario being related to the first event scenario by at least one common participant or contextual cue;
in response to detecting the second event scenario and without requiring further user input, retrieving the stored information bundle of the first event scenario based on the at least one common participant or contextual cue; and
providing, on the mobile device and during the second event scenario, a collection of user interface elements associated with the retrieved information bundle, the collection of user interface elements for accessing the one or more documents identified in the retrieved information bundle.

21. A system comprising:
one or more processors;
memory coupled to the one or more processors and operable for storing instructions, which, when executed by the one or more processors, cause the one or more processors to perform operations, comprising:
at a first moment in time, detecting on a mobile device a first event scenario presently occurring in proximity to the mobile device, the first event scenario being defined by one or more participants and one or more contextual cues concurrently monitored by the mobile device and observable to a user of the mobile device;
in response to detecting the first event scenario and without requiring further user input, creating in real-time an information bundle associated with the first event scenario, the information bundle comprising respective data identifying the one or more participants, the one or more contextual cues, and one or more documents that are accessed by the user of the mobile device during the first event scenario; and
storing the information bundle at a storage device associated with the mobile device, wherein the information bundle is retrievable based on at least one of the one or more contextual cues.

22. A computer-implemented method, comprising:
identifying one or more participants and one or more contextual cues present in proximity to the mobile device, the one or more participants and the one or more contextual cues defining a first event scenario;
identifying one or more documents that are accessed during the first event scenario;
deriving respective identifiers, functional labels, and descriptive labels for the one or more participants, contextual cues, and documents; and
creating, at the end of the first event scenario, the information bundle associated with the first event scenario, the information bundle comprising the derived identifiers, functional labels, and descriptive labels for the one or more participants, contextual cues, and documents.

23. A computer-implemented method, comprising:
building a personal profile for a user based on respective information bundles of one or more previously recorded event scenarios, the personal profile indicating one or more routines that were performed by the user during the one or more previously recorded event scenarios, each routine having an associated location and set of data items accessed during the previously recorded event scenarios;
detecting a current location of the mobile device;
determining that the current location of the mobile device is outside of a geographical area associated with the one or more routines; and
suggesting an alternative routine to the user on the mobile device, where the alternative routine modifies the associated location of one of the one or more routines based on the associated location of the routine and the current location of the mobile device.
